(19) United States
(12) Patent Application Publication
(10) Pub. No.: US 2004/0156064 A1
(43) Pub. Date: Aug. 12, 2004

(54) Printing methods and apparatus

(76) Inventors: Kevin Owen, Meridian, ID (US); Scott Lee, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/360,458

(22) Filed: Feb. 7, 2003

(51) Int. Cl. G06F 3/12; G06F 15/00; G06F 7/00

(52) U.S. Cl. 358/1.13; 358/1.15; 700/223

(57) ABSTRACT

One representative embodiment provides for a printing system which includes a computer configured to present a document file for printing as a multi-page print job, and a plurality of print engines accessible by the computer. The printing system further includes a controller configured to identify, for each page to be printed of the print job, a next-available print engine from the print engines for printing the page, and to cause the identified print engine to print the page. Another representative embodiment provides for a collating apparatus having input trays for receiving pages of a multi-page print job, output trays for receiving the multi-page print job, and a controller to cause the collating apparatus to draw pages from the input trays, to sort or collate the pages, and to place the pages in the output trays in the form of the print job.

### BACKGROUND

In printing a document from a computer (such as a personal computer or a workstation, for example) it is typically desirable that the document be printed in the fastest possible manner. Fast printing of documents is desirable for at least two reasons: (1) the printed document is available to the user sooner; and (2) when a printer is shared between two or more users, it is desirable to make the printer available to other users in the quickest possible manner. Methods and apparatus are constantly being developed to achieve faster printing speed of a document via a printer. These methods and apparatus include at least: (1) increasing the page-per-minute speed at which an image is formed on sheets of imaging media (such as paper); (2) increasing the speed at which imaging media is moved through the printer; and (3) decreasing the time-to-first-copy for the printed document. Notwithstanding these developments, there is still a desire to achieve even faster printing times for printing a document.

Frequently, rather than desiring to print a single copy of a document, a user will desire to print multiple copies of a document. Whether a single copy or multiple copies of a document are to be printed, the overall printing exercise for a particular document is known as a “print job”. Thus, a “print job” can include printing pages 1 through “N” of a document, or it can include printing copies 1 through “N” of the document. (It will be noted that “N” for the number of pages of the document, and “N” for the number of copies of the document to be printed, are not necessarily the same, and that the letter “N” is used herein to identify the last item (e.g., the last page of a document to be printed, or the last copy to be printed of the document).) A printer is typically described as including a “print engine”. A print engine includes the mechanical, electrical, electro-mechanical, and software components necessary to generate the image on sheet media and present the final imaged sheet media to a user. The mechanical components of a print engine can include, for example, the transport mechanisms required to move sheet media from an input tray (where blank sheet media is provided) to an output tray (where the final imaged sheet media is made available to the user. The electro-mechanical components of a print engine can include, for example, the components necessary to form the image on a page of sheet media (such as by an electrophotographic imaging process commonly used in a laser printer, or a wet-ink imaging process used in an inkjet imaging process). (These latter components are typically described as the “imaging section” of a print engine.) The electrical components of a print engine can include, for example, an electrical power supply required to drive the mechanical and electro-mechanical components of the print engine. The software components of a print engine can include, for example, components used to regulate the image formation on sheet media by the imaging section. The print engine is typically driven by a printer driver program which is typically resident within a computer generating the print job.

The length of time to print a print job by a given printer can be affected by a number of factors. These can include: (1) physical limitations of the mechanical and electro-mechanical components of the print engine of the printer; (2) the specific software used in the print engine of the printer; (3) whether the final print job is to be printed as single-sided copy (i.e., “simplex” printing) or a double-sided copy (i.e., “duplex” printing); (3) the printer driver being used to drive the print engine; (4) the file format of the document being printed; and (5) the size of the print job file (in bytes).

It is thus desirable to provide methods and apparatus for increasing the speed at which a print job can be printed.

### SUMMARY

One representative embodiment of the present invention provides for a printing system which includes a computer configured to present a document file for printing as a multi-page print job, and a plurality of print engines accessible by the computer. The printing system further includes a controller configured to identify, for each page to be printed of the print job, a next-available print engine from the plurality of print engines for printing the page, and to cause the next available print engine to print the page.

Another representative embodiment of the present invention provides for a method of printing a multi-page print job. The method includes providing a plurality of print engines, identifying a first available print engine from the plurality of print engines, and printing a first page of the multi-page print job from the first available print engine. The method further includes identifying a next available print engine from the plurality of print engines, and printing a next page of the multi-page print job from the next available print engine.

A third representative embodiment of the present invention provides for a printing apparatus for printing a document file as a multi-page print job. The printing apparatus includes a plurality of print engines, each print engine having an associated print engine output tray. A controller is configured to identify, for each page to be printed of the multi-page print job, a next-available print engine from the plurality of print engines for printing the page, and to cause the next available print engine to print the page and to discharge the page to the associated print engine output tray. The printing apparatus further includes a collator configured to receive the pages of the multi-page print job from the output trays. The collator has at least one collator output tray. The controller is further configured to cause the collator to draw the pages from the print engine output trays, to perform one of a sort process or a collate process on the pages, and to place the pages in the at least one collator output tray.

These and other aspects and embodiments of the present invention will now be described in detail with reference to the accompanying drawings, wherein:

### DESCRIPTION OF THE DRAWINGS

FIG. 1 is a plan view diagram depicting a print job wherein copies of pages of the print job are collated.

FIG. 2 is a plan view diagram depicting a print job wherein copies of pages of the print job are sorted.

FIG. 3 is a schematic diagram depicting a printing system in accordance with one embodiment of the present invention.

FIG. 4A is a diagram depicting how a print job can be printed using a method in accordance with an embodiment of the present invention.

FIG. 4B is a diagram depicting a print log which can be produced for the print job depicted in FIG. 4A.

FIG. 5 is a diagram depicting a cover page printed by a printer while printing a print job using a method in accordance with an embodiment of the present invention.

FIG. 6 is a schematic diagram depicting a printing system in accordance with another embodiment of the present invention.

FIG. 7 is a side view depicting a document printing apparatus in accordance with a further embodiment of the present invention.

FIG. 8 is a side view depicting a document collator/sorter in accordance with yet another embodiment of the present invention.

FIG. 9 is a side view depicting a variation of the document collator/sorter depicted in FIG. 8.

FIG. 10 is a flowchart depicting a method of printing and collating a print job in accordance with an embodiment of the present invention.

FIG. 11 is a flowchart depicting a method of printing and sorting a print job in accordance with an embodiment of the present invention.

FIG. 12 is a flowchart depicting a method of printing a print job in accordance with another embodiment of the present invention.

FIG. 13 is a flowchart depicting a method of collating a print job in accordance with a further embodiment of the present invention.

FIG. 14 is a flowchart depicting another method of collating a print job in accordance with an embodiment of the present invention.

### DETAILED DESCRIPTION

Representative embodiments of the invention described herein provide for methods and apparatus for printing a print job using a plurality of print engines. Generally, for each page of the print job, a determination is made as to which of the plurality of print engines is next available to print the page, and the page is then printed using the determined print engine. After the print job has been printed, the pages of the print job can be assembled into the final print job. Selected embodiments of the present invention also provide for automated methods and apparatus for assembling the printed pages into the final print job.

As used herein, the expression “print job” will be used to describe the product of a selected printing of a document file from a computer. The document file can include text, graphics, pictures, etc., and combinations thereof. A print job can include one or more copies of the document. In the following discussion, the following nomenclature will be used:

“Cn” will represent any copy within a print job, wherein “C1” represents the first copy, and “CN” represents the last copy;

“PAn” will represent any page of a copy within a print job, wherein “PA1” represents the first page of the copy, and “PAN” represents the last page of the copy;

“PTRn” will represent any of a plurality of print engines used to print the print job, wherein “PTR1” represents the first such print engine, and “PTRN” represents the last such print engine.

From the foregoing it will be appreciated that the letter “N” at the end of “C”, “PA” or “PTR” is indicative of the last such item, and does not need to be the same in all instances of usage. For example, a print job can include four copies of a document, wherein the document is five pages in length. Thus, for this particular print job, “N” in “CN” is equal to four (four copies), and “N” in “PAN” is equal to five (five pages).

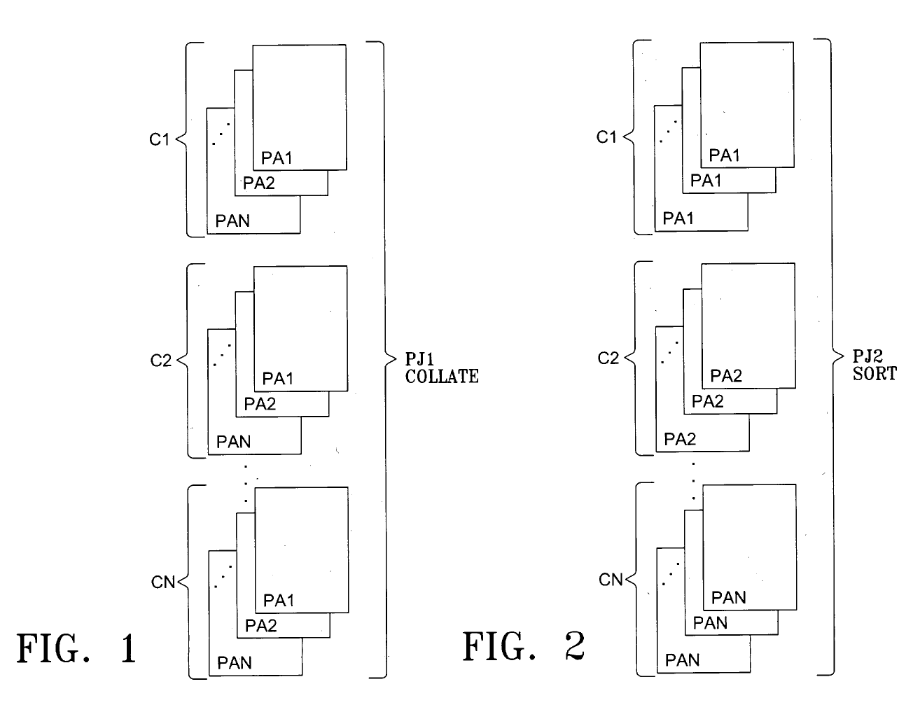

In the case of the print job including two or more copies of the document, the copies can generally be assembled in one of two primary manners: the copies can include collated pages, or they can include sorted pages. FIG. 1 is a graphical representation of a print job “PJ1” wherein the pages of each copy are collated. As can be seen in FIG. 1, the print job “PJ1” includes copies “C1” through “CN”, and each copy includes pages “PA1” through “PAN”. FIG. 2 is a graphical representation of a print job “PJ2” wherein the pages of each copy are sorted. As can be seen in FIG. 2, the print job “PJ2” includes copies “C1” through “CN”. Copy “C1” of “PJ2” includes only pages “PA1”, copy “C2” includes only pages “PA2”, and so on, such that copy “CN” of “PJ2” includes only pages “PAN”. Embodiments of methods and apparatus in accordance with the present invention allow for both types of print jobs (collated print jobs sorted print jobs) to be printed and assembled.

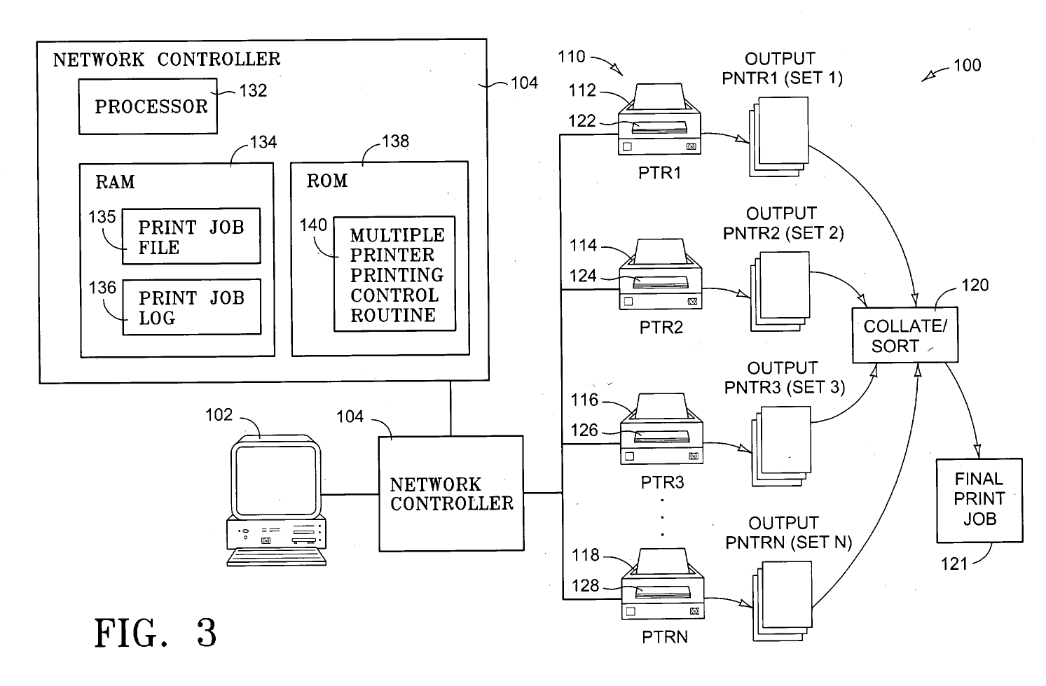

Turning to FIG. 3, a schematic diagram depicts a printing system 100 in accordance with one embodiment of the present invention. The general architecture of the printing system 100 will first be described, after which a general description of the operation of the printing system will be provided. The printing system 100 includes a computer 102 configured to present a document file for printing as a multi-page print job. The computer 102 can be, for example, a personal computer or a workstation. The printing system 100 further includes a plurality of print engines 110, which are here indicated separately as PTR1, PTR2, PTR3 and so on to PTRN (numbered respectively as 112, 114, 116 and 118), which are each accessible by the computer 102. Each print engine 112, 114, 116 and 118 has an associated print engine output tray 122, 124, 126 and 128. The output trays 122, 124, 126 and 128 are configured to receive the output (i.e., printed pages) from the respective print engines 112, 114, 116 and 118. The outputs from the respective print engines 112, 114, 116 and 118 are represented graphically as “SET1”, “SET2”, “SET3” and “SETN”. The printing system 100 also includes a controller 104 which is configured to identify, for each page to be printed of the print job, a next-available print engine from the plurality of print engines 110 for printing the page, and to cause the next available print engine to print the page. In the example depicted in FIG. 3, the controller 104 is a network controller. In this instance, the network controller 104 is in signal communication with the computer 102 and the plurality of print engines 110. When the controller 104 is a network controller, more than one computer 102 can be placed in signal communication with the controller 104 such that the printing system 100 further includes a plurality of computers, thus allowing multiple users to take advantage of the printing system 100. The controller 104 can include a processor 132, a RAM memory device 134, and a ROM memory device 138. Non-limiting examples of RAM memory include a hard disk drive, read-write-rewritable semiconductor memory devices, magnetic memory media (such as diskettes and magnetic tapes and the like), rewritable-CDs and DVDs, and flash cards. Non-limiting examples of ROM memory devices include non-rewritable semiconductor memory devices, write-once CDs and DVDs, and write-protected magnetic media.

In one example, the plurality of print engines 110 are resident within a plurality of stand-alone printers (such as are depicted in FIG. 3) which are in signal communication with the network controller 104. The expression “stand-alone printer” means a fully self-sufficient printer, having a separate imaging media source (e.g., a dedicated paper tray), a dedicated print engine for forming an image on the imaging media, and a dedicated imaging media output tray. It will be appreciated, however, that certain software used to operate the stand-alone printer (such as a printer driver, for example) can be resident outside of the stand-alone printer. Thus, in an office environment wherein two or more stand-alone printers are placed in the office, each of which is in signal communication with the network controller 104, then each stand-alone printer can serve as one of the plurality of print engines 110. In another example (described more fully below), the print engines 110 can be ganged together, such as by being placed in a common printing apparatus enclosure, in which case the print engines 110 can (but are not required to) share common components, such as common firmware, a common power supply, etc.

In operation, the computer 102 generates a print file job, which can be stored initially in the computer in the form of an electronic (digital) document file. When a user of the computer 102 thus desires to print the document file as a multi-page print job, a command is sent to the network controller 104 from the computer 102, and a print job file (which includes the document file, as well as instructions for printing the print job) can be transferred from the computer 102 to the network controller 104, and stored in the RAM memory 134 in the network controller 104 as “Print Job File” 135. (However, in one variation the print job file can remain resident within the computer 102). The network controller 104 can then access a “Multiple Printer Printing Control Routine” 140, which can be stored in the ROM memory 138 in the network controller 104. The Multiple Printer Printing Control Routine 140 can be executed by the processor 132 in the controller 104 to perform printing of the Print Job File 135, as follows. The processor 132 polls the plurality of print engines 110 to determine which of the print engines 112, 114, 116 and 118 is next available for printing the first page of the Print Job File 135. In the event where two or more of the print engines 112, 114, 116 and 118 are available to print the first page of the print job, then the Multiple Printer Printing Control Routine 140 can be provided with a hierarchical default to select a preferred one of the available print engines 112, 114, 116 and 118 over the other available print engines. The first page of the Print Job File 135 is then printed using the selected print engine from the print engines 110, and the printed page is deposited in an output tray (122, 124, 126 or 128) associated with the selected print engine 112, 114, 116 or 118. The processor 132 then polls the print engines 110 to determine which of them is next available for printing the next page of the print job. This process of identifying the next available print engine from among print engines 112, 114, 116 and 118, and printing the next page of the print job, is continued until the last page of the print job has been printed. At the end of the printing of the print job the controller 104 can signal the user (such as via the computer 102) that the print job has been printed.

In the above description the controller 104 was indicated as polling the print engines 110 to determine a next-available print engine from among the plurality of print engines. The polling process is generally a passive process, wherein the burden is on the controller to identify the next available print engine by performing a polling process. However, in one variation the process of identifying the next available print engine can be an essentially active process, wherein one or more of the print engines 110 notifies the controller 104 that the print engine is available for printing a page of the print job. The active process of identifying the next available print engine includes the use of an interrupt notification, wherein a print engine 122, 124, 126 and/or 128 notifies the controller 104 that the print engine is available printing a page of the print job. For example, if a notification connection is established between one or more of the print engines 110, then the so-connected print engine can notify the controller that the print engine is available to print a page of the print job. Examples of notification connections which can accomplish such an active notification to the controller 104 of the availability of a print engine (112, 124, 126, and/or 128) include a connection according to IEEE standard 1284, a parallel connection made through equipment available from Centronix Corporation, Inc., and/or a USB (“Universal Serial Bus”) connection. The active notification of availability of a print engine (from among print engines 110) can includes not only the fact that a print engine has printed the then-current page of the print job, but also the fact that a print engine is not available due to a paper jam, a “low toner” or “low ink” condition, and other conditions which can enable or disable a print engine from the ability to print a page of the print job. When the print engines 110 are connected to the controller 104 in a network-type connection (as depicted in FIG. 3), the a protocol, such as the “SNMP” (“Simple Network Management Protocol”) can be used for active notification of the controller 104 of the availability or non-availability of any one of the print engines 110. In addition to the above referenced examples of active identification of a next-available print engine, so-called “printer-traps” can also be used. A “printer trap” is a signal from a print engine or a printer (from among print engines 110, for example) to a controller (controller 104, for example) causing the controller to send one or more pages of a print job to the print engine (or printer) which generated the “printer trap” signal. The “printer trap” command can be issued by a print engine or printer when the print engine or printer changes state (e.g., is now available to print a page of the print job). Accordingly, in the following description the act of “identifying the next available print engine” (or “identifying the next available printer”) is understood to include both passive and active methods of identifying the availability of a print engine and/or printer, as described above.

It should be understood that a page does not have to be printed and deposited in one of the output trays 122, 124, 126 or 128 before the processor 132 polls for the next available print engine. For example, once the processor 132 transmits a page of the print job to one of the print engines 112, 114, 116 and 118, the processor can then immediately poll for the next available print engine. The print engines 112, 114, 116 and 118 can be configured to notify the processor 132 is a page does not print for some reason (out of paper, paper jam, out of ink or toner, etc.), and the controller can then resend the page to a different one of the print engines 112, 114, 116 and 118.

The availability of a given print engine to print a given page of the multi-page print job can be based on a number of factors. In the most basic configuration, the determination of availability is based on whether a print engine is currently available to receive, and immediately print, a page of the print job, or whether the print engine is currently engaged in printing a different print job (or another page of the current print job). The availability of a print engine can also be based on the possibility or impossibility of the print engine to print a page of the print job. For example, if a given print engine is out of paper, or out of toner or ink (generically, “imaging substance”), or experiencing a paper jam or other malfunction, then it will be impossible for that print engine to print a page of the print job, and the print engine will thus not be available to print a given page of the print job.

Further, where a print job specifies that different pages of the print job are to be printed in a manner different from other pages of the print job, then the availability of a print engine to print a page of the print job can be affected by the then-current page to be printed (i.e., whether a print engine is even capable of printing a page of the print job). For example, a print job can specify that the first page of each copy of the print job is to be printed on letterhead paper. In this instance, if letterhead paper is available to only a single print engine, then only that print engine will be “available” to print the first page of each copy of the print job. Likewise, if selected pages of a print job are to be printed in color (i.e., other than in only black-and-white or grayscale), and only one print engine in the plurality of print engines is capable of color printing, then for pages of the print job to be printed in color, only the print engine, capable of printing in color will be “available” to print those color pages. Similar considerations can exist for imaging media size (e.g., letter size or legal size), imaging media type (e.g., envelopes or plain paper, transparencies or plain paper, colored stock or white stock; etc.). Accordingly, when a user submits a document to the controller 104 for printing as a multi-page print job, the print job file can include information regarding the special considerations for any given page or pages of the document, and thus in the subsequent printing process the “availability” of a print engine to print a given page of the document for the print job will be determined based on this information.

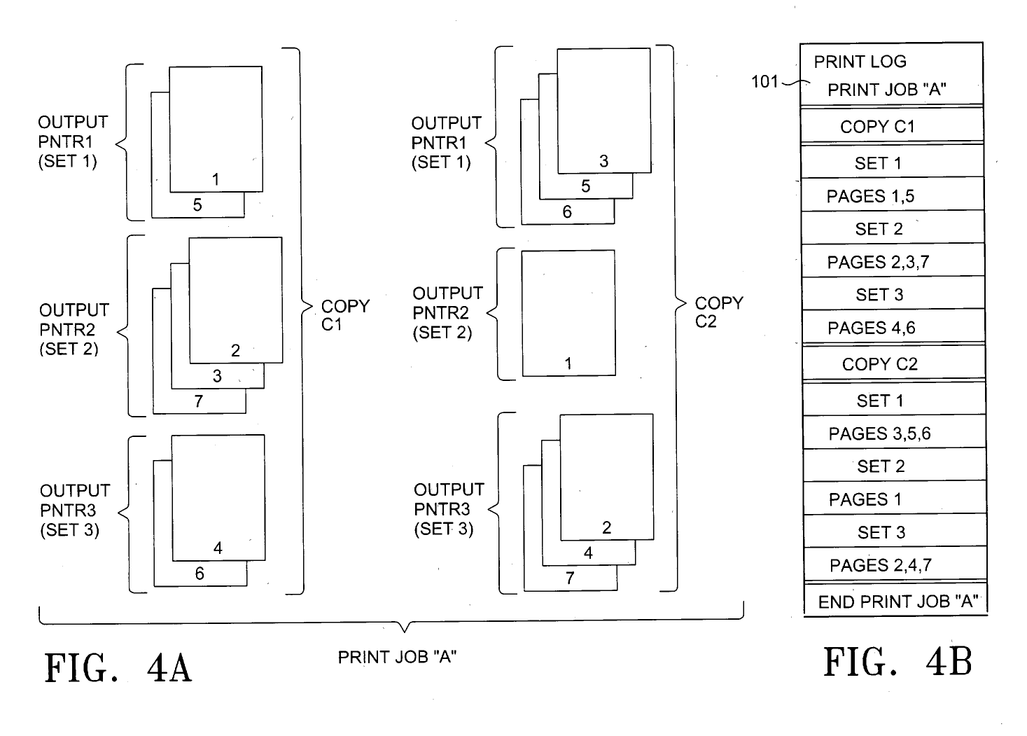

FIG. 4A is a graphical representation of an example of the process of printing a print job using a plurality of print engines, described above with respect to FIG. 3. FIG. 4A depicts the outputs from three print engines for a “Print Job A”, wherein the print job includes printing two copies (“Copy C1” and “Copy C2”) of a document having seven pages. In the example depicted in FIG. 4A, only print engines 112, 114 and 116 of FIG. 3 are used (for example). The print engines 112, 114 and 116 of FIG. 3 thus produce respective outputs of “Output PNTR1” (or “SET1”), “Output PNTR2” (or “SET2”), and “Output PNTR3” (or “SET3”). As indicated, SET1 of “Copy C1” includes pages 1 and 5, SET2 of “Copy C1” includes pages 2, 3 and 7, and SET3 of “Copy C1” includes pages 4 and 6. Likewise, SET1 of “Copy C2” includes pages 3, 5 and 6, SET2 of “Copy C2” includes page 1, and SET3 of “Copy C2” includes pages 2, 4 and 7. As can be seen in FIG. 4A, the pages of the copies “C1” and, “C2” are not printed in any predetermined order by the three printers (112, 114, 116, FIG. 3), but have instead been printed on a “next-available printer” basis. The expression “set” will be used herein with respect to the output of a print engine to indicate the pages of a print job printed by the print engine and placed in an output tray or output device dedicated to the print engine.

Turning back to FIG. 3, following printing of the sets (SET1, SET2, SET3, etc.) of a print job, the sets are assembled in a “Collate and/or Sort” process 120, and are rendered as the final print job 121. While the sets SET1, SET2, SET3 and SETN can be assembled manually in the Collate and/or Sort process 120, preferably the Collate and/or Sort” process is performed automatically, as will be described further below.

Depending on whether copies of a multi-copy print job are to be collated (as in FIG. 1) or to be sorted (as in FIG. 2), then the printing process regulated by the controller 104 can be selectively varied. Specifically, when a print job is to be printed using the printing system 100 of FIG. 3 and the print job is to include multiple collated copies of a document composed of pages PA1 through PAN, then the Multiple Printer Printing Control Routine 140 can be configured to print the first copy (e.g., copy “C1” of FIG. 4A) having pages “PA1” through “PAN”, followed by printing the second copy (e.g., copy “C2”) of pages “PA1 through “PAN”, and so on, until the last copy “CN” of the print job has been printed. However, when a print job is to be printed using the printing system 100 of FIG. 3 and the print job is to include multiple sorted copies of a document composed of pages PA1 through PAN (as in FIG. 2), then the Multiple Printer Printing Control Routine 140 can be configured to first print the first copy (e.g., copy “C1” of FIG. 4A) having only pages “PA1”, followed by printing the second copy having only pages “PA2”, and so on, until the last copy “CN” of the print job, having only pages “PAN”, has been printed. In this way, when assembling the final print job (121, FIG. 3) it will always be possible to pick the uppermost sheet from one of the sets to assemble a copy of the print job, regardless of which print engine is used to print the next page of a copy of the print job. For example, referring to FIG. 4A, in collating the pages “1” through “7” of copy “C1”, page “1” will be first picked from SET1, and page “2” will be next picked from SET2. Page “3” in SET2 will then be available to be next picked, having been previously uncovered by the picking of page “2”. Page “4” will then be picked from SET3. Page “5” in SET1, having been previously uncovered by picking page “1”, will then be available to be picked next. Likewise, page “6” in SET3 will then be next available for picking, having been previously uncovered by the picking of page “4”. Finally, page “7” in SET2 will available for picking, having been previously uncovered by the picking of pages “2” and “3” in SET2. A review of “COPY C2” of “Print Job A” of FIG. 4A indicates that a similar picking process will be available to collate the pages of the second copy “C2”, without the possibility of a next-page-to-be-picked being covered by another page.

This foregoing discussion of presenting pages in the sets assumes that the print engines 112, 114, 116 and 118 (FIG. 3) are configured to present the sets (SET1, SET2, SET3, SETN, FIG. 3) to respective output trays 122, 124, 126 and 128 so that the last printed page of each set will be presented for the collate/sort process 120 in a manner that allows the uppermost page in each set to be picked to assemble the final print job. The term “uppermost page” is a relative term, and indicates the page presented for next picking in assembly of the final print job 121. For example, assume the pages of the sets SET1, SET2, SET3 and SETN in FIG. 3 are presented to the respective output trays 122, 124, 126 and 128 in a face-down manner (such that the first printed page of each set is located at the bottom of the set in the output tray, and is downward-facing). The pages of each set can then be picked in one of two ways. First, the set can be left in the face-down position, and the downward facing first page of the set can be picked first by picking the page from the bottom of the set. Alternately, the set can be inverted prior to picking, such that the upward-facing first page of the set can be picked first.

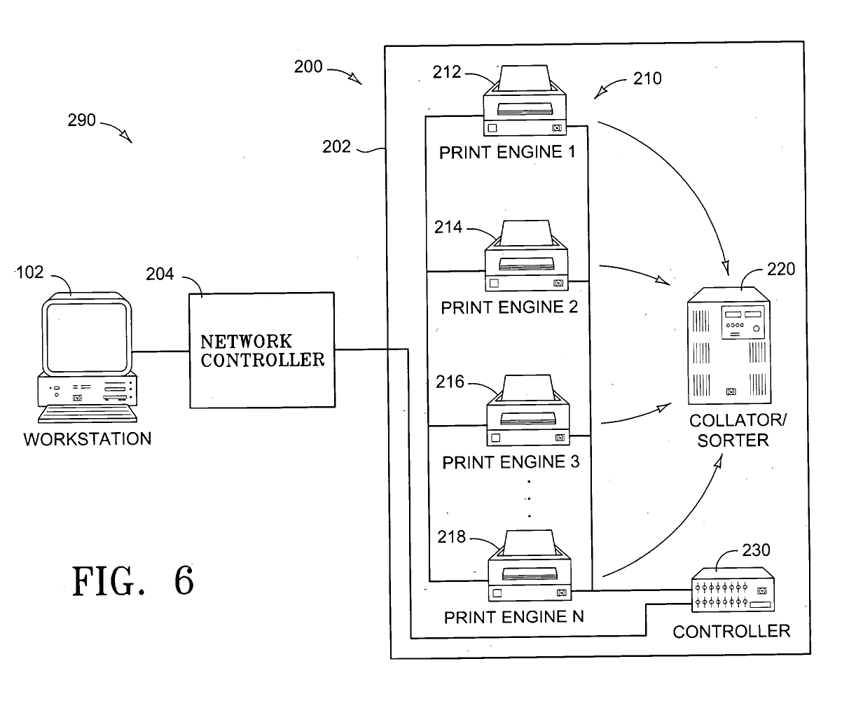

The above process of printing a print job was described as printing the first page of the print job first, followed by printing the second page of the print job, and so on, until the last page of the print job has been printed. However, in one variation the last page of the print job can be printed first, followed by printing the next-to-last page of the print job, and so on, until the first page of the print job has been printed. Thus, as can be seen, the order in which the pages of the print job are printed, the manner in which the pages of each set are placed in the output trays of the print engines (i.e. face-up or face down), and the manner in which the pages of each set are presented to (face-up or face down) and picked from (bottom page first, or top page first), are all interdependent. Accordingly, in the following discussion, the expressions “first page” and “first copy” are not intended to necessarily be associated with respective uppermost, upward facing pages and copies of a print job, but rather are intended to mean the pages and copies rendered first by the plurality of print engines 110 of the printing system 100 of FIG. 3 so that the resulting imaged pages can be assembled into the final print job 121, according to the variables described above. This convention applies not only to the printing system 100 of FIG. 3, but the printing system 290 to be described below with respect to FIG. 6, and other methods and apparatus described herein.

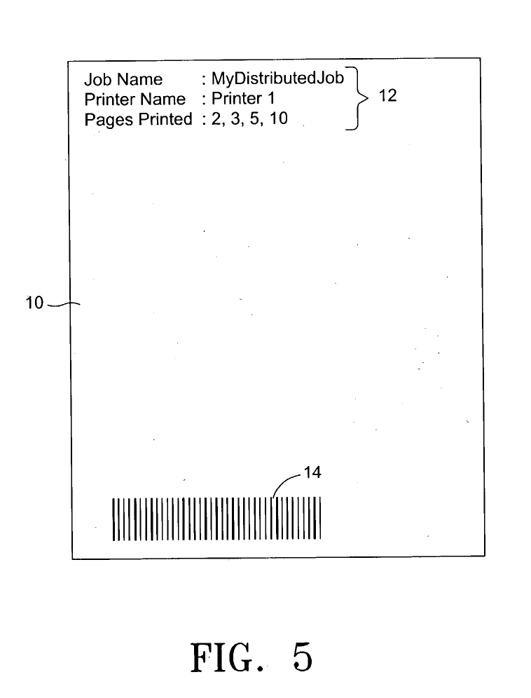

As generally described above with respect to FIG. 3, each print engine 112, 114, 116 and 118 can provide at least one page of the print job to the associated output trays 122, 124, 126 and 128 to thereby produce sets SET1, SET2, SET3 and SETN of pages of the print job, which can then be assembled using the collate/sort process 120 into the final print job 121. As also described, the collate/sort process can either be performed manually or automatically. In one embodiment wherein the collate/sort process 120 is to be performed automatically, the controller 104 can be configured to create a Print Job Log 136 (“print log”) identifying the pages of the print job output by each print engine 112, 114, 116 and 118 to the associated output tray 122, 124, 126 or 128. FIG. 4B is a diagram depicting how a print job log 101 (corresponding to Print Job Log 136 of FIG. 3) can be generated by the controller 104 (FIG. 3) in accordance with an embodiment of the present invention. The print log 101 (FIG. 4B, or 136 of FIG. 3) can be stored in the RAM memory 134 (FIG. 3) of the controller 104. As can be seen, the print job log 101 of FIG. 4B for the Print Job “A” of FIG. 4A is separated into each copy “C1” and “C2” of the print job. Within each copy “C1”, “C2” of the print log 101, the specific pages of each copy are logged for the specific set “SET1”, “SET2” and “SET3” corresponding to the outputs from the print engines 112, 114 and 116 of FIG. 3. The print log 136 (FIG. 3) can then be accessed by a controller (such as the network controller 104) to facilitate automating the collate/sort process 120. In one embodiment (described more fully below), the print log 136 can be read directly by a controller (such as the network controller 104, or via a separate controller), and used to control a collating apparatus (as described below) to perform the collate/sort process 120. In another embodiment, the controller 104 can be configured to read the print log 136 and cause each print engine 112, 114,116 and 118 which can print at least one page of the print job to print a cover sheet. Each cover sheet printed by a print engine 112, 114, 116 and 118 can identify the pages of the print job printed by the respective print engine. The cover sheets printed by a print engine 112, 114, 116 and 118 can then be provided to the respective output tray 122, 124, 126 and 128 for each respective print engine 112, 114, 116 and 118. An exemplary cover sheet 10 is depicted in FIG. 5. As indicated in FIG. 5, the pages of a print job printed by the associated print engine can be identified in a human-readable form 12. In this instance, the set of pages associated with the cover sheet 12 can then be used to manually perform the collate/sort process 120 of FIG. 3. Alternately, the pages of the print job printed by a print engine 110 (FIG. 3) can be identified on each cover sheet 10 (FIG. 5) in machine-readable form. In the example depicted in FIG. 5, the machine readable form of indicating the pages of the print job printed by a specific print engine is a bar code 14. That is, the bar code 14 can indicate, in machine-readable form, that Printer 1 has printed pages 2, 3, 5 and 10 of a copy of a print job (as indicated by the “human readable” form 12).

As described above, the collate-or-sort process 120 of FIG. 3 can be performed either manually or automatically. In one embodiment wherein the collate-or-sort process 120 is performed automatically, the outputs SET1, SET2, SET3 and SETN of the corresponding print engines 112, 114, 116 and 118 are manually provided to an automated “collating apparatus”, which can then collate or sort the pages from the sets into the final print job 121. In another embodiment wherein the collate-or-sort process 120 is performed automatically, the outputs SET1, SET2, SET3 and SETN of the corresponding print engines 112, 114, 116 and 118 are automatically (and directly) provided to an automated “collating apparatus”, which can then collate or sort the pages from the sets into the final print job 121.

Turning to FIG. 6, a schematic diagram depicts a printing system 290 in accordance with another embodiment of the present invention. The printing system 290 includes a computer 102 (similar to computer 102 of FIG. 3, as described above), and a printing apparatus 200. The printing apparatus 200 can be placed in direct communication with the computer 102, or, more commonly, the printing apparatus 200 can be placed in direct communication with the computer 102 via a network controller 204. The printing apparatus 200 is configured to print a document file (which can originate from the computer 102, for example) as a multi-page print job. The printing apparatus 200 automatically performs a similar function as the plurality of print engines 110 (FIG. 3) and the collate/sort process 120 (FIG. 3). The printing apparatus 200 of FIG. 6 includes a plurality of print engines 212, 214, 216 and 218, identified collectively as 210. The printing apparatus 200 further includes a collator/sorter 220 (which will referred to hereafter as “collator 220” for the sake of simplicity), and a controller 230. The plurality of print engines 210, the collator 220, and the controller 230 can all be resident within a printing apparatus enclosure 202. Alternately, the controller 230 can be located outside of the enclosure 202. For example, the controller 230 can be resident within the network controller 204, or within the computer 102.

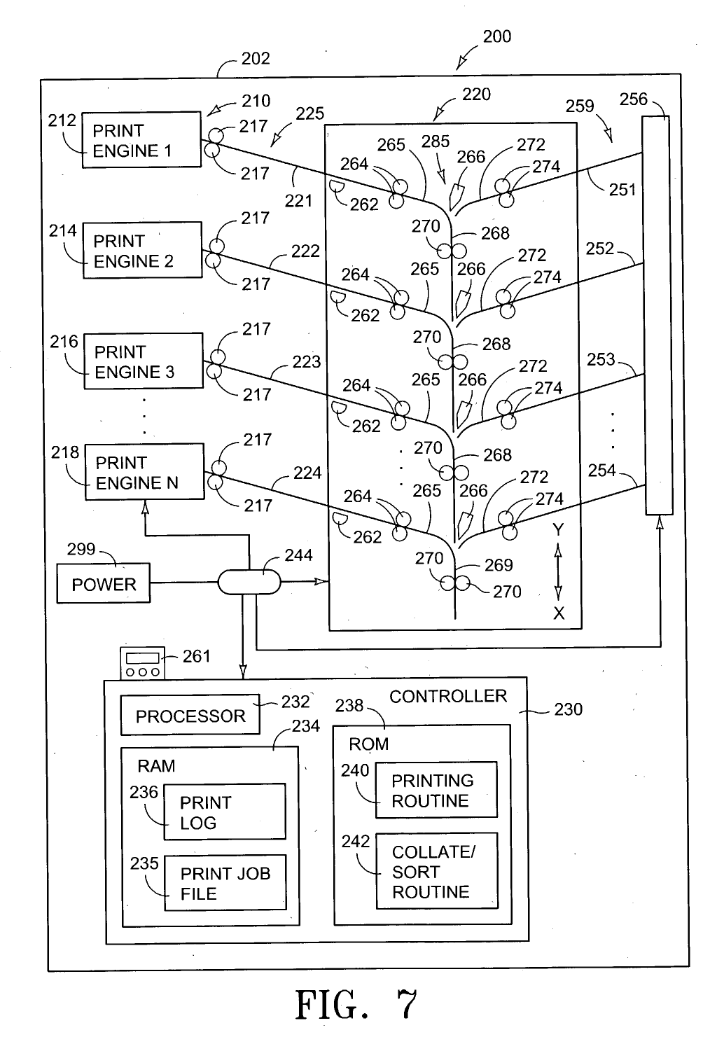

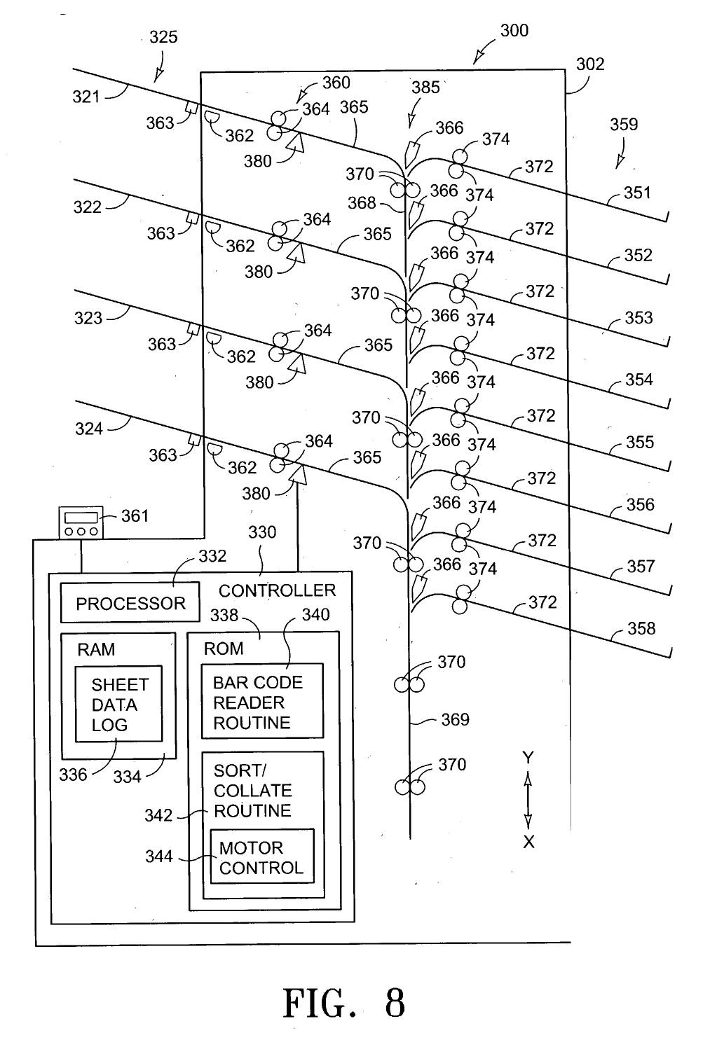

Turning to FIG. 7, a side view diagram depicts the printing apparatus 200 of FIG. 6. The components of the printing apparatus 200 will first be described, after which the operation of the printing apparatus will be described. As shown in FIG. 7, each print engine 212, 214, 216 and 218 includes an associated print engine output tray, respectively 221, 222, 223 and 224 (indicated collectively as 225). As will be described more fully below, the print engine output trays 225 also function as input trays for the collator 220. As will also be described more fully below, the controller 230 is to identify, for each page of a multi-page print job to be printed by the printing apparatus 200, a next-available print engine from the plurality of print engines 210 for printing the page. The controller 230 is further configured to cause the next available print engine (from print engines 212, 214, 216 and 218) to print the page and to discharge the page to the print engine output tray (from trays 221, 222, 223 and 224, collectively identified as 225) associated with the selected print engine (212, 214, 216 or 218). As explained above, the collator 220 is configured to receive the pages of the multi-page print job from the print engine output trays 225. The collator includes one or more collator output trays 251, 252, 253 and 254 (identified collectively as 259). As will be described more fully below, the controller 230 is further configured cause the collator 220 to selectively draw the pages from the print engine output trays 225, to perform one of a sort process or a collate process on the pages, and to selectively place the collated or sorted pages into the collator output trays 259. Typically, each copy (e.g., “COPY C1” and “COPY C2”, FIG. 4A) that makes up part of a print job is placed in a separate-collator output tray 251, 252, 253 or 254 (FIG. 7) so that a user can retrieve the individual copies of the print job from individual output trays 259. If more copies are produced than there are collator output trays 259, then the printing process can be halted and a user notified (such as via computer 102 or by a control panel 261 on the printing apparatus 200. Alternately, the printing apparatus 200 (and more specifically, the controller 230) can be configured to place more than one copy of the print job in each print engine output tray 251, 252, 253, 254. A finishing unit 256 (such as a stapler, hole punch, sheet binder, etc.), can be provided to the collator output trays 259 to provide a finishing process to the copies of the print job.

The printing apparatus 200 can include a power supply 299, which can provide power directly to the controller 230. Power from the power supply 299 can also be provided to the plurality of print engines 210, the collator 220, and the finishing unit 256, all under control of the controller 230, and using the power switching circuit 244 to allow the power to be selectively supplied to the print engines, collator and finisher, as necessary.

The controller 230 is depicted as including a processor 232, a RAM memory device 234, and a ROM memory device 238, both of which can be accessed by the processor 232. The RAM memory device 234 can be used to store the print job file 235, as well as a print log 236 (described above with respect to FIG. 4B, and also described more fully below). The ROM memory device 238 can include a “Printing Routine” 240, as well as a “Collate/Sort Routine” 242. The Printing Routine 240 can be used to control distribution of the print job file 235 to the plurality of print engines 210 on a next-available-print-engine basis for each page of the print job, in the manner described above. The Printing Routine 240 can also be used to create the print log 235. In addition to controlling distribution of the print job to the plurality of print engines 210, the Printing Routine 240 can also be used to control the imaging process of a given page by each of the plurality of print engines 210 (i.e., the process of generating an image on a page of sheet media), as well as movement of sheet media through the print engine using powered rollers and the like (not shown). In a similar manner, the Collate/Sort Routine 242 can be used to control picking of sheets of media from the print engine output trays 225, and directing the sheets to the collator output trays 259, in correct order so as to result in copies of the final print job being presented to a user in the collator output trays 259. The Collate/Sort Routine 242 can also be used to control operation of the various electro-mechanical components (not shown) in the collator 220.

In operation, a print job is sent via a computer (102, FIG. 6) to the controller 230 (FIG. 7), and is then stored in the RAM memory device 234 as a print job file 235. The print job file 235 can include not only a digital representation of the images to be printed, but also special instructions for printing (such as the size of imaging media to be used, the layout of an image on a page (e.g., portrait or landscape), whether the pages are to be printed as simplex or duplex, finishing to be applied to the copies making up the print job, etc. Under the direction of the Printing Routine 240, the processor 232 then reads the print job file 235 and polls the print engines 210 to determine which of them is first available for printing the “first” page of the print job. As described above, the “first” page of the print job can actually be the bottom page in a copy, but is considered as being the “first” page since it will be the page first printed. As also previously described, the determination of which page of the final print job constitutes the “first” page for purposes of printing the print job can be based on how the sheets will be placed in the print engine output trays 225 (i.e., face-up or face-down), and the manner in which the collator 220 handles sheets received from the print engine output trays 225 (e.g., whether the collator 220 includes a sheet reversing loop or not, etc.).

As soon as the “first” page of the print job has been sent to an identified one of the print engines 212, 214, 216, 218 for printing, the processor 232 will poll the print engines 210 to determine which one is next available for printing the next page of the print job. The process continues until all of the pages of the print job are printed. During this process, the processor 232 can be creating a print log 236, which is a record of which pages of the print job were printed by which of the print engines 212, 214, 216, 218. As indicated in FIG. 4B, described above, the print log 236 (FIG. 7) can identify the pages of each copy of the print job printed by the associated print engine. The pages printed by each of the print engines 212, 214, 216, 218 will be placed in the respective print engine output trays 221, 222, 223, 224 by powered rollers 217. Following the printing process, the processor 232 can then read the print log 236 to perform the collate or sort process using the collator 220. In the example depicted in FIG. 7, it is assumed that the top page of each copy in the print job is the “first” page printed, and that the printed pages are placed in the print engine output trays 225 (which also function as “collator input trays”) in a face-down manner. Accordingly, a pick roller 262 associated with each collator input tray 221, 222, 223, 224 can pick the bottom-most sheet from the tray (the bottom-most sheet being the first sheet placed in the tray by the respective print engine 211, 212, 213, 214). The pick rollers 262 move the sheets of paper from the collator input trays 225 into a set of feed rollers 264 (one set for each collator input tray 225) and into an input guide 265 (one input guide 265 for each collator input tray 225). The sheets are then moved from the input guides 265 into a central sheet guide 268. It will be noted that the collator 220 also includes a plurality of output guides 272, one output guide for each collator output tray 259, and that the output guides 272 are configured to receive pages of the print job from the central sheet guide 268. Specifically, the collator 220 can include a plurality of selectively reversible sheet drives 270 (shown here as reversible powered feed rollers) placed along the central sheet guide 268 and configured to selectively drive pages of the print job received within the central sheet guide in opposing first (“X”) and second (“Y”) directions. The collator 220 is also provided with a plurality of diverter gates 266, each diverter gate being positioned relative to the central sheet guide 268 and an associated output guide 272. Each diverter gate 266 is selectively actuatable to cause pages in the central sheet guide 268 to be diverted from the central sheet guide to an output guide 272, where a pair of discharge rollers 274 (one set for each output guide 272) then direct the sheet to a dedicated output tray (from among output trays 259) associated with the particular diverter gate 266. It will be noted that the lowermost segment 269 of the central sheet guide 268 should be of sufficient length to completely receive a sheet of paper from the lowermost input tray 224, and allow the sheet to be diverted to the lowermost collator output tray 254. Although the lowermost segment 269 of the central sheet guide 268 is depicted here as being straight, it can also be curved to allow a lower profile for the collating apparatus 220. It will also be noted that while FIG. 7 depicts a printing apparatus 200 having four print engine output trays 221, 222, 223, 224 and an identical number of collator output trays 251, 252, 253, 254, this is merely a coincidence. Generally, the printing apparatus 200 should include at least two print engines (and thus two print engine output trays), and at least one collator output tray. In one example, the printing apparatus can include three print engines and twenty collator output trays, thus allowing twenty copies (making up a single print job) to be provided separately to a user.

The order in which sheets of the print job are picked from print engine output trays 225 and selectively placed in the collator output trays 259 will be determined by the processor 232, under the direction of the Collate/Sort Routine 242, and according to the print log 236. The controller 230 will thus be configured to read the print log 236 and to use the print log to direct the collating apparatus (collator) 220 to perform one of a sorting process or a collating process on the pages in the plurality of print engine output trays 225 to thereby place the pages into the final form of the print job in the plurality collator of output trays 259. If a print job consists of multiple copies (and assuming the copies have been printed in seriatim order by the print engines 210), then the collate/sort routine 242 can direct the first copy to be assembled in the first collator output tray 251, the second copy to be assembled in the second collator output tray 252, and so-on.

By way of example, if the next sheet in a print job is to be moved from print engine output tray 223 to collator output tray 252, then the pick roller 262 nearest tray 223 moves the sheet out of the tray 223, into the feed rollers 264 (i.e., the feed rollers 264 closest to tray 223). The feed rollers 264 move the sheet into the input guide 265 closest to the input tray 223, and from there the sheet enters the central sheet guide 268, moving in downward direction “X”. Reversible drive rollers 270 move the sheet down (“X”) into the central guide 268 until the sheet is completely received within the central guide. The diverter gate 266 closest to collator output tray 252 is then actuated so that a sheet moving upward (“Y”) in the central sheet guide 268 will be diverted into the output guide 272 closest to output tray 252. The reversible drive rollers 270 then reverse direction and move the sheet in the central guide 268 upwards (“Y”) until the actuated diverter gate 266 diverts the sheet out of the central sheet guide 268 into the output guide 272 nearest output tray 252. Discharge rollers 274 then engage the sheet, and discharge it to output tray 252. The processor 232 then causes the next page of the print job to be picked from one of the print engine output trays 221, 222, 223, 224 and directed to the appropriate collator output tray 251, 252, 253 or 254, as guided by the print log 236 and the collate/sort routine 242. The process continues until the final print job has been assembled in one or more of the collator output trays 259, as appropriate to the specific print job.

FIGS. 6 and 7 depict a unitary printing apparatus 200 that can perform both the printing and the collating/sorting of a print job. In the apparatus 200, the pages from the print engines 210 are automatically provided to the collator 220 by virtue of the shared print engine output trays (collator input trays) 225. However, as described previously, in some instances it will be desirable to use a group of stand-alone printers to print the print job. In this latter instance, it will generally not be practical to automatically provide the outputs from the plurality of printers to a collating apparatus, and so the outputs will typically be provided to a collating apparatus manually. That is, after the print job has been printed using a group of printers, a person will walk around among the printers and pick up the outputs (“sets”) from the various printer output trays, and then manually place the sets in a collating apparatus.

FIG. 8 depicts a side view depicting a collating apparatus 300 that can be used to manually receive outputs from a plurality of printers (or print engine) in the form of “sets” for a multi-page print job, printed according to methods described above with respect to FIG. 3. Although the apparatus 300 is described as a “collating” apparatus, as will become apparent, the apparatus 300 can be used to perform a collating process, and/or a sorting process. The collating apparatus 300 has a similar structure to the collator 200 of FIG. 7, but with some differences, as will be explained. The collating apparatus 300 includes a plurality of input trays 321, 322, 323 and 324, indicated collectively as 325, which are configured to receive pages of a multi-page print job. More specifically, each input tray 321, 322, 323 and 324 is configured to receive a set from each printer producing a set of the multi-page print job, so that in the example shown, up to four stand-alone printers can be used to generate the sets. The collating apparatus 300 further includes a plurality of output trays 351 through 358 (inclusive), generally indicated by 359, which are configured to collectively receive the multi-page print job in the final form. In the example shown, a print job having up to seven copies can be assembled by the collating apparatus 300 and placed in output trays 351 through 357, inclusive. Output tray 358 is reserved for a special function, which will be described below. The collating apparatus 300 also includes a controller 330 which is configured to cause the collating apparatus 300 to draw the pages from the plurality of input trays 325, to perform one of a sort process or a collate process on the pages, and to place the pages in the plurality of output trays 351 through 357 in the form of the print job. The collate/sort controller 330 will be described more fully below.

The collating apparatus 300 includes certain functional sheet-handling components 385 for moving sheets of media from the input trays 325 to the output trays 359. These components 385 are similar to sheet-handling components 285 of the collator 220 of FIG. 7, perform essentially the same function. Specifically, the collating apparatus 300 (FIG. 8) includes: pick rollers 362 (similar to pick roller 262 of FIG. 7) to pick sheets of media from the input trays 225; feed rollers 364 for moving sheet media into input guides 365; a central sheet guide 368 for receiving sheet media from the input guides 365; a lowermost segment 369 of the central sheet guide 368 sized to receive a full sheet of media; reversible drive rollers 370 allowing sheet media in the central sheet guide 368 to be selectively moved in either a downward direction “X” or an upward direction “Y”; output guides 372 configured to receive sheet media from the central sheet guide 368; selectively actuatable diverter gates 366 configured to allow sheet media to be diverted from the central sheet guide 368 into an output guide 372 associated with any one of the output trays 359; and output drive rollers 374 configured to move the sheet media along the output guides 372 and into the output trays 359.

As described above with respect to FIG. 5, when stand-alone printers are used to generate the sets of the multi-page print job, then each set can be provided with a cover sheet 10 which contains information identifying the pages of the multi-page print job present in the particular set. The information can be in human-readable form 12, as well as machine-readable form (such as by bar code 14) which is generated by the print-engine controller which controls the printing of the sets. Thus, when each set from the printers used to generate the sets of the multi-page print job are placed in the input trays 325 (FIG. 8) of the collating apparatus 300, the cover sheet 10 (FIG. 5) can be placed in the input tray in a position to be the first sheet from the set picked by the pick rollers 362 (FIG. 8). Accordingly, the collating apparatus 300 can further include a code-reading apparatus 360 configured to read the machine-readable form of the pages of the print job printed on each cover sheet. In the example shown in FIG. 8, the code reading apparatus 360 is a plurality of bar-code readers 380, a separate bar-code reader being associate with each input tray 321, 322, 323, 324. Thus, as a cover sheet is picked from an input tray 325 by a pick roller 362 and moved into the input guide 365, the bar code on the cover sheet will move across the bar-code reader 380, thus allowing the bar-code reader to generate sheet data (i.e., data indicating the pages of the print job included in the set that was provided with the just-picked cover sheet). The controller 320 can then receive the sheet data and use it to direct the collating apparatus 300 to perform one of a sorting process or a collating process on the pages in the input tray associated with the cover sheet. The bar code on the cover sheet can include not only information about the specific pages present in the set, but also information about the print job, such as the number of copies in the print job, whether pages are to be sorted or collated, etc. The controller 330 can include a RAM memory device 334 for storing the sheet data log 336, as well as a ROM memory device 338. The ROM memory device 338 can include a bar code reader routine 340 to operate the bar-code readers 380 and generate the sheet data log 336. The ROM memory device 338 can also include a “Sort/Collate Routine” 342 to direct the collating apparatus 300 to perform a collate process or a sort process on the sheets placed in the input trays 325 in accordance with the sheet log 336, in order to produce the final print job to the output trays 359. Part of the Sort/Collate Routine 342 can be a motor control routine 344 to operate the pick rollers 362, the feed rollers 364, the reversible drive rollers 370, the diverter gates 366, and the discharge rollers 374.

In operation, a user can place each set of a multi-page print job generated by a plurality of print engines (such as a group of stand-alone printers) in separate input trays from among input trays 321, 322, 323 and 324. Each set will be provided with a cover sheet. In the example depicted, the cover sheet will be face-up on the top of each set, and each set will be placed face down in an input tray 325 so that the cover sheet will be the first sheet picked by a pick roller 362, and the bar code on the cover sheet will be moved past the bar code reader 380. The user will then -signal the collating apparatus 300 to perform the collate or sort process on the sets to produce the final print job. This can be done using a user interface 361. Each input tray 325 can be provided with a sheet detector 363 in communication with the controller 330 so that the controller will be able to determine which of the input trays 325 contains a set. For each input tray 325 containing a set, the controller 330 will sequentially cause the cover sheet of each set to be moved past the bar code reader 380 associated with the input tray, and will read the bar-code information to generate the sheet data log 336. After each cover sheet has been read, it can be placed in a dedicated discard tray 358. Once all of the cover sheets have been individually read and the sheet data log 336 created, the collating apparatus 300 can perform a collate process or sort process on the remaining sheets in the input trays 325 according to the sheet data log 336 and, under the control of the Sort/Collate Routine 342, can place the final print job in the output trays (from among trays 351 through 357, inclusive). A user can then retrieve the final copies of the print job from the output trays (from among trays 351 through 357), and can discard the cover sheets from tray 358.

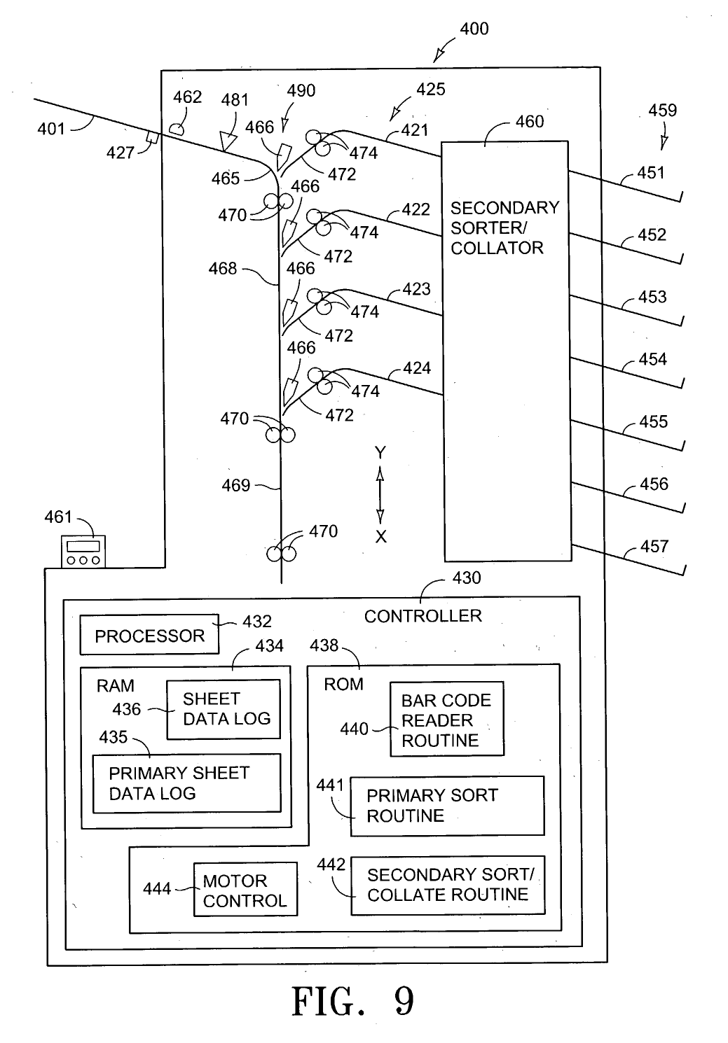

The collating apparatus 300 of FIG. 8 requires that a user separate the various sets before placing them in the input trays 325. This can become cumbersome when a large number of printers have been used to generate the sets which will ultimately form the final print job. It is therefore desirable to provide a collating apparatus in which all of the sets printed by a plurality of printers for a multi-page print job can be placed in a single input tray, and then assembled into the final print job from there. FIG. 9 is a side view depicting a collating/sorting apparatus 400 (hereinafter, “collating apparatus 400”) which can receive all of the sets printed by a plurality of printers for a multi-page print job in a single input tray 401, and then assemble the pages into the final print job from there upon receipt of an instruction from a user (via the user input 461) to perform the sort/collate process. Collating apparatus 400 includes a secondary sorter/collator 460, which can include all of the sheet handling components 385 of the collating apparatus 300 of FIG. 8, and including the bar-code readers 380 and the sheet detectors 363. In the collating apparatus 400 of FIG. 9, the input trays 325 of FIG. 8 are replaced with secondary input trays 421, 422, 423 and 424 (collectively identified as 425). Likewise, the output trays 359 of FIG. 8 are replaced with output trays 451 through 457 (inclusive) of FIG. 9, and tray 457 of FIG. 9 functions similarly to the discard tray 358 of FIG. 8. It will be appreciated that the number of secondary input trays 425 and the number of output trays 459 depicted in FIG. 9 are exemplary only, and that more or less trays can be used in each position. The collating apparatus 400 of FIG. 9 further includes a controller 430 which is similar to (but not identical to) the controller 330 of FIG. 8. Specifically, controller 430 of FIG. 9 can include all of the functionality of the controller 330 of FIG. 8, including: a processor 432; a RAM memory device 434 which can contain a sheet data log 436 (similar to sheet data log 336 of FIG. 8); a ROM memory device 438; a “Secondary Collate/Sort Routine” 442 (which can function the same as the CollateSort Routine of FIG. 8) to allow the secondary sorter/collator 460 to assemble pages placed in the secondary input trays 425 into the final print job in output trays 459; and a bar-code reader routine 440 which can perform the same functions as the bar-code reader routine 340 of FIG. 8. However, the controller 430 of FIG. 9 is further configured to cause the collating apparatus 400 to draw the pages from the primary input tray 401, to perform a sort process on the pages, and to place the pages in the plurality of secondary input trays 425.

As indicated above, the collating apparatus 400 of FIG. 9 includes a primary input tray 401 configured to receive, as a single stack of sheets, all of the sets to be assembled into the final print job. The stack of sheets can thus include cover sheets separating one set from another within the stack. If the cover sheets are provided with a machine readable code (such as bar code 14 of FIG. 5), then the collating apparatus 400 (FIG. 9) can determine which sheets in the single stack belong to a specific set, and can separate the sets and place them in the secondary input trays 425. Accordingly, the collating apparatus 400 can further include a primary code-reading device (such as barcode reader 481) which can read the machine-readable code on each cover sheet and, in response, generate primary sheet data which can be stored in the RAM memory device 434 as a primary sheet data log 435. The controller 430 can then use the sheet data from the primary sheet data log 435 to direct the collating apparatus 400 to place each set in an associated secondary input tray (from among trays 421, 422, 423 and 424), under the direction of a primary sort routine 441. It is assumed that the single stack of sheets to be provided to the primary input tray 401 is provided as a plurality of unitary sets, such that each set is separated by a cover sheet, and that the pages specific to a particular set follow the cover sheet and are not placed under a different cover sheet. For example, if the uppermost cover sheet in the single stack of sheets identifies specific pages as belonging to the set, then those identified pages will follow directly the associated cover sheet, and will not be placed under a non-associated cover sheet.

The collating apparatus 400 includes a primary sorter 490 which is configured to receive sheets from the primary input tray 401, and place the sheets into the secondary input trays 425 by set. The primary sorter 490 depicted in FIG. 9 assumes that the single sheet stack will be placed in the primary input tray 401 in a face-up position, and that a cover sheet will be provided in a face-up position on the top of the sheet stack. The primary sorter 490 includes a pick roller 462 configured to pick the uppermost sheet from the sheet stack placed in the primary input tray 401, and to move the sheet into an input guide 465. A code-reading device (bar code reader 481) can then read the machine-readable code (e.g., bar code 14 of FIG. 5) on the cover sheet as the cover sheet is moved past the bar-code reader 481 (FIG. 9), and can generate primary sheet data in response thereto. The primary sheet data can be stored in the RAM memory device 434 as primary sheet data log 435. According to the information in the primary sheet data log 435, the controller 430 (under the direction of the primary sort routine 441) can then subsequently cause the next pages in the sheet stack, identified by the primary sheet data log 435 as belonging to the set identified by the cover sheet, to be picked and placed in a selected one of the secondary input trays 425. The next sheet on the sheet stack will thus be a second cover sheet identifying the second set in the sheet stack. The second cover sheet can then be picked from the stack, read to identify the number of pages in the set associated with the cover sheet, and the identified pages will thus be picked from the sheet stack and placed into a second one of the secondary input trays 425. This process will be continued until all of the sheets in the sheet stack in primary input tray 401 have been placed into secondary input trays from among trays 421, 422, 423 and 424. It will be noted that the cover sheet for each set will also be placed in a secondary input tray 425 designated to received the sheets belonging to the set. In this way, the information on the cover sheet will be available to the code-reading devices in the secondary sorter collator 460 so that the sheets can be assembled into the final print job.

As shown in FIG. 9, the primary sorter 490 includes the pick roller 462 and the primary guide 465, both described above, as well as a central sheet guide 468 configured to receive pages of the print job from the input guide 465. The central sheet guide 468 can include a lowermost portion 469, configured to receive an entire sheet so that the sheet can then be moved into the lowermost secondary input tray 424. A set of reversible drive rollers 470 allows a sheet within the central sheet guide 468 to be selectively moved downward in direction “X” while being picked from the primary input tray 401, or upwards in direction “Y” while being distributed to one of the secondary input trays 425. The primary sorter 490 further includes a plurality of output guides 472, each output guide being associated with a respective secondary input tray 421, 422, 423 or 424 and configured to receive pages or sheets of the print job from the central sheet guide 468. A plurality of selectively actuatable diverter gates 466 allow a sheet in the central sheet guide 468 to be diverted into any one of the secondary input trays 421, 422, 423 or 424, according to the primary sheet data log 435 and the primary sort routine 441.

By way of example, assume that a single sheet stack forms a multi-page print job consisting of three sets from -three printers. Further, each set is prefaced by a cover sheet identifying the sheets belonging to the associated set. The sheet stack is placed in the primary input tray 401, and a user initiates the process (via the user interface 461) to place the sheets in the sheet stack into the form of the final print job. The uppermost sheet in the sheet stack (being a cover sheet) is then picked from the sheet stack in the primary input tray 401, and the bar code reader 481 (and controller 430) then determine that the set associated with the picked cover sheet consists of five sheets of the print job. The controller 430 then directs the picked cover sheet, and the next five sheets from the sheet stack in the primary input tray 401, to be placed into the first secondary input tray 421 by the primary sorter 490. The next sheet on the sheet stack in the primary input tray 401 will then be a second cover sheet, and the process of reading the second cover sheet, and placing the second cover sheet and the indicated following sheets which make up the second set, will then be performed to place the sheets into the second input tray 422. The process is then repeated for the final (third) remaining set in the primary input tray, which can be placed in third secondary input tray 423. A sheet detector 427, which can be in communication with the controller 430, can then indicate to the controller 430 that no more sheets are present in the primary input tray 401. Thereafter, the controller 430 can perform the final collating or sorting of the sheets in the secondary input trays 425, to place the final print job in the output trays 459, in a manner similar to the manner described above with respect to collating apparatus 300 of FIG. 8.

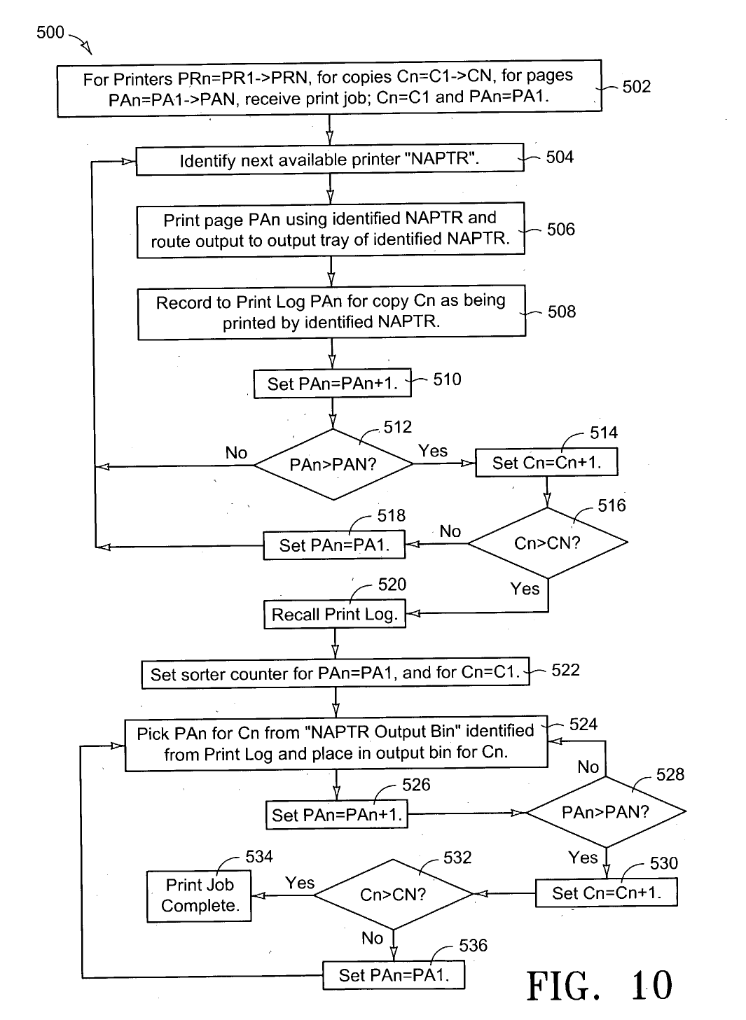

Turning now to FIG. 10, a flowchart 500 depicts an example of how a multi-page document can be printed and collated into a final print job in accordance with an embodiment of the present invention. The flowchart 500 generally corresponds to the printing apparatus 200 depicted in FIG. 7, and can be carried out by the controller 230 under the direction of the printing routine 240 and the collate/sort routine 242 of FIG. 7. Accordingly, the following description of the flowchart 500 of FIG. 10 will make reference to various components of the printing apparatus 200 of FIG. 7, although it will be understood that other printing apparatus can also be used to implement the flowchart 500 of FIG. 10. In the flowchart 500 of FIG. 10, a multi-page print job is initiated by a user via a computer (e.g., computer 102 of FIG. 6), and is transmitted to the printing apparatus (200, FIG. 7). At step 502 of the flowchart 500, for the available printers consisting of printers PR1 through PRN, and for copies “Cn” of the print job consisting of copies “C1” through “CN”, and for pages “PAn” consisting of pages “PA1” through “PAN” for each copy, a copy counter (which can be resident in RAM memory) is set to select a copy “Cn” as copy “C1”, and a page counter (which can also be resident in RAM memory) is set to select page “PAn” of the copy “Cn” as “PA1”. (The copy counter and the page counter can be established within the RAM memory device 234 of FIG. 7.) At step 504, the processor (232, FIG. 7) identifies the next available printer “NAPTR” from among printers “PR1” through “PRN”. At step 506 the page “PRn” of the copy “Cn” is printed, using the next available printer “NAPTR” identified in step 504. The output from the selected printer is then routed to an output tray (e.g., any one of trays 225 of FIG. 7) associated with the identified printer. At step 508 the page “PAn” of copy “Cn” just printed is recorded in a print log (such as print log 236, FIG. 7). At step 510 the page counter is increased by a value of one. Then, at step 512, the processor (232, FIG. 7) checks to determine whether the page counter exceeds the number of pages (“PAN”) that are to be printed for the then-current copy “Cn” for the print job. If the page counter does not exceed the number of pages that are to be printed for the copy “Cn” of the print job, then the processor (232, FIG., 7) returns to step 504, and the next available printer is identified for printing the next page of the copy “Cn”, and so on until the last page “PAN” of the copy “Cn” is printed, as determined at step 512. Once the last page for a given copy “Cn” of the print job is printed, then at step 514 the copy counter is incremented by the value of one, and at step 516 the processor (232, FIG. 7) checks to determine whether the copy counter exceeds the number of copies (“CN”) that are to be printed for the print job. If the copy counter does not exceed the number of copies that are to be printed for the print job, then the processor (232, FIG., 7) goes to step 518, and the page counter is reset to “PA1”, and the next copy of the print job is printed. Thus, steps 504 through 518 are repeated until all pages of all copies of the print job have been printed.

Once all pages of all copies of the print job have been printed, the processor (232, FIG. 7) proceeds to step 520 to begin the process of collating the printed pages (now placed in the print engine output trays 221, 222, 223 and/or 224, FIG. 7) into the final print job, and placing them into the output trays (251, 252, 253, and/or 254, FIG. 7) of the printing apparatus 200 (FIG. 7). Specifically, at step 520 (FIG., 10) the processor (232, FIG. 7) recalls and reads the print log (236, FIG. 7, generated in step 508 (FIG. 10), and which can be represented by the print log 101 of FIG. 4B and 236 of FIG. 7). At step 522 the processor (232, FIG. 7) sets a sorter counter (which can be contained in RAM memory device 234 of FIG. 7) for pages “PAn” of each copy “Cn” of the print job to the first page “PA1” of the fist copy “C1”. The sorter counter thus includes a page counter and a copy counter, and can be the page counter and copy counter used during the printing process. At step 524, the collator 220 (FIG. 7) picks the page “PAn” (identified in the page counter) from the next-available output bin (“NAPTR Output Bin”) identified from the print log (236, FIG. 7) and places the page in an output bin (from bins 251, 252, 253, 254 of FIG. 7) for the copy currently identified “Cn” (identified in the copy counter) of the print job. At step 526 the page counter is incremented by the value of one, and then at step 528 the processor (232, FIG. 7) checks to determine whether the now-current page “PAn” identified by the page counter exceeds the number of pages (“PAN”) for the copy. If the now-current page “PAn” identified by the page counter does not exceed the number of pages (“PAN”) for the current copy “Cn” being assembled, then the processor (232, FIG. 7) returns to step 524 and picks the next identified page “PAn” from the appropriate output bin (“tray”) according to the print log (236, FIG., 7). However, if the now-current page “PAn” identified by the page counter at step 528 exceeds the number of pages (“PAN”) for the then-current copy “Cn”, then this indicates that the current copy “Cn” has been assembled, and the processor (232, FIG. 7) proceeds to step 530 to increment the copy counter by a value of one. At step 532 the processor (232, FIG. 7) checks to determine whether the now-current copy “Cn” identified by the copy counter exceeds the number of copies (“CN”) for the print job. If the now-current copy “Cn” identified by the copy counter does not exceed the number copies (“CN”) for the current print job being assembled, then the processor (232, FIG. 7) goes to step 536 to reset the page counter to “PA1” to begin picking the pages for the next copy, and control is returned to step 524. However, if at step 532 the now-current copy “Cn” identified by the copy counter exceeds the number of copies (“CN”) for the print job, then this indicates that the print job has been completely assembled, and the process is terminated at step 534.

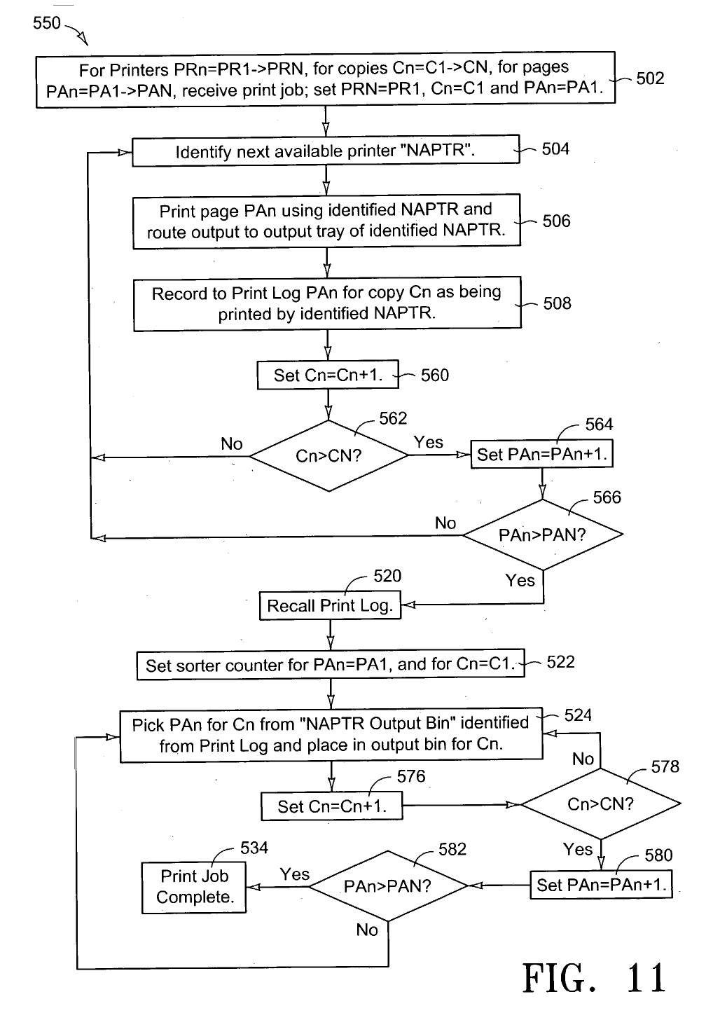

Turning now to FIG. 11, a flow chart 550 depicts an example of how a multi-page document can be printed and sorted into a final print job in accordance with an embodiment of the presenter invention. The flowchart 550 generally corresponds to the printing apparatus 200 depicted in FIG. 7, and can be carried out by the controller 230 under the direction of the printing routine 240 and the collate/sort routine 242 of FIG. 7. The flowchart 550 of FIG. 11 is to be compared with the flowchart 500 of FIG. 10. Whereas the flowchart 500 of FIG. 10 provides for collating a print job (e.g. placing the pages into a form of pages 1, 2, 3, . . . , 1, 2, 3, . . . , etc.), the flowchart 550 provides for 15 sorting a print job (i.e., placing the pages into a form of pages 1, 1, 1, . . . , 2, 2, 2, . . . , etc.). The flowchart 550 of FIG. 11 includes certain identically numbered steps as the flowchart 500 of FIG. 10, except as follows. During the printing process in the flowchart 500 of FIG. 10, the page counter is first increased at step 510 (prior to increasing the copy counter), whereas in the flowchart 550 of FIG.11 the copy counter is first increased (see step 560). That is, flowchart 500 (FIG. 10) is based on first printing pages “PA1” through “PAN” for a copy, and then when all pages for a copy have been printed, the copy counter is incremented and pages “PA1” through “PAN” for the next copy are printed (as indicated by steps 510, 512, 514, 516 and 518). On the other hand, the printing process set forth in the flowchart 550 of FIG. 1 is based on printing all copies “C1” through “CN” of a first page “PA1” required for the print job, followed by printing all copies “C1” through “CN” of a second page “PA2” for the print job, and so on, until all copies “C1” through “CN” of the last page “PAN” for the print job have been printed (as set forth in steps 560, 562, 564 and 566 of flowchart 550). Accordingly, the step 518 of the flowchart 500 of FIG. 10 is not required in the flowchart 550 of FIG. 11, since there is no need to reset the page counter after all of the copies of the page “Pn” have been printed for the sort process depicted in FIG. 11.

Similarly, beginning at step 524 of both flowcharts 500 (FIG. 10) and 550 (FIG. 11), the collate process of flowchart 500 differs from the sort process flowchart 550 as follows. In the flowchart 500 of FIG. 10, after the first page to be assembled into the final print job has been picked at step 524, then in steps 526, 528, 530 and 532 the processor (232, FIG. 7) checks to determine whether pages “PA1” through “PAN” have been assembled for the then-current copy “Cn”. If not, the assembly process continues, but if so, the copy counter is incremented and the assembly process for pages “PA1” through “PAN” for the next copy are performed. On the other hand, in steps 576, 578, 580 and 582 of the flowchart 550, the processor 232 (FIG. 7) first checks to determine whether all of the first pages “PA1” have been assembled into the first copy “CA1”, whether all of the second pages “PA2” have been assembled into the second copy “CA2”, and so on, until it has been determined that all of all of the last pages “PAN” have been assembled into the last copy “CN”. Accordingly, the step 536 of the flowchart 500 of FIG. 10 is not required in the flowchart 550 of FIG. 11, since there is no need to reset the page counter after all of the copies of the page “Pn” have been assembled in the sort process of FIG. 11.

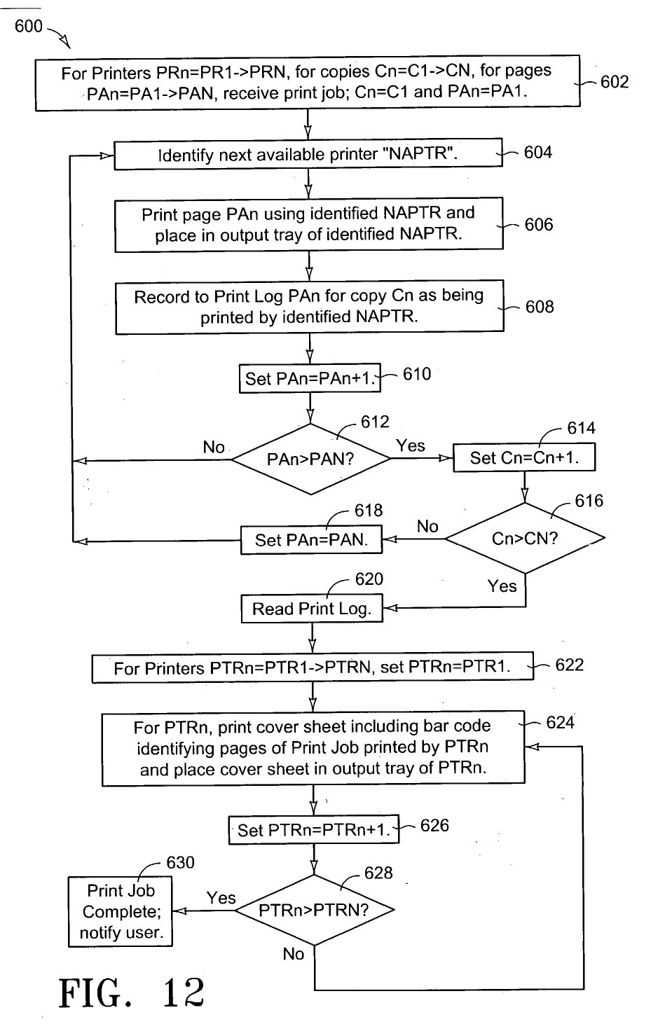

Turning now to FIG. 12, a flowchart 600 depicts an example of a method of printing a multi-page print job in accordance with an embodiment or the present invention. The flowchart 600 shown in FIG. 12 can correspond to using the printing system 100 of FIG. 3 to print a multi-page print job, which can later be sorted or collated either manually or using the collating apparatus 300 of FIG. 8. Accordingly, the following description of the flowchart 600 of FIG. 12 will make reference to FIG. 3 for the purpose of indicating components that can be used to implement steps of the flowchart, although it is understood that other apparatus can be used to perform the process described in the flowchart 600. At step 602 of the flowchart 600 of FIG. 12, a controller (104, FIG. 3) initiates settings for printing a multi-page print job which includes copies “Cn” from “C1” to “CN”, each copy consisting of pages “PAn” from “PA1” through “PAN”. Print engines (or “printers” for simplicity) “PA1” through “PAN” (generically indicated by “PAn”, and corresponding to print engines 110 of FIG. 3) are accessible by the controller 104 (FIG. 3) for printing the print job. The controller 104 receives the print job, and initializes a copy counter as “C1” and a page counter as “PA1”. In step 604, the controller 104 (FIG. 3) begins by polling for the first next-available-printer (“NAPTR”), and identifies one of the print engines PTR1 through PTRN as “NAPTR”. At step 606 the controller 104 (FIG. 3) prints the first page “PA1” (identified generically as “PAn” in the drawing) for the first copy of the multi-page document and places it in the output tray of the print engine that printed the page. (As described previously, “first page” and “first copy” do not necessarily correspond to “uppermost page” and “uppermost copy” in the final assembled print job, but mean instead “first page to be printed” and “first copy to be printed”, according to the logic for most efficiently producing the imaged pages of the print job. The logic can be based on available computer readable memory for storing the document to be printed, the orientation in which printed pages will be placed in an output tray and/or placed into an input tray of a collating device, etc.) After the page has been printed, at step 608 the controller (104, FIG. 3) records in a Print Log (e.g., Print Job Log 136 of FIG. 3, or 101 of FIG. 4B) the identification of the page “Pn” that was just printed, and the copy “Cn” of the print job that the page will be used in. The controller (104, FIG. 3) then increments the page counter by the value of one at step 610, and at step 612 the controller checks to determine whether the value in the page counter exceeds “PAN”, the last page of the copy. If the page counter does not exceed “PAN”, control is returned to step 604, and steps 604 through 612 are repeated to print all pages of the first copy “C1”. Once the page counter exceeds “PN” as determined at step 612 (indicating that then-current copy “Cn” being printed has been fully printed), then at step 614 the copy counter is incremented by the value of one. The copy counter is then checked at step 616 to determine if it exceeds “CN” (the total number of copies to be printed for the print job), and if not, the page counter is reset to “P1” so that the first page of the next copy (and the subsequent pages) can be printed at steps 604 through 612, as described above.

If, at step 616, it is determined that the last copy of the pint job has been printed, then at step 620 the print log is read. At step 622, for each printer “PTRn” which was used to print the print job (being printers “PTR1 through PTRN in the example), a printer counter is set to “PTR1”. Then in step 624 the controller (104, FIG. 3) causes the printer currently identified in the printer counter to print a cover sheet. The cover sheet includes data from the print log (e.g., 101, FIG. 4B), and specifically includes the identification of the pages of each copy of the print job that were printed by the currently-identified printer. If no pages were printed by the printer, then the cover sheet can identify that no pages for a particular copy were printed. As described previously, the cover sheet can be printed in both human-readable and machine-readable form. The cover sheet is then placed in the output tray of the printer currently-identified in the printer counter. At step 626 the printer counter is incremented by a value of one, and the controller (104, FIG. 3) checks at step 628 to see if the printer log exceeds “PTRN” (the last printer used to print part of the print job). If the printer counter is less than “PTRN”, control returns to step 624 and the cover sheet for the then-currently identified printer is printed. Once the last cover sheet has been printed (as determined at step 628 by the printer counter exceeding “PRN”), the printing process terminates, and a user can be notified.

In one variation on the process depicted in FIG. 12, rather than printing all copies of the print job and then printing the cover sheets, a first copy can be printed, followed by printing cover sheets for that copy, a second copy can be printed, followed by printing cover sheets for that copy, and so on, until the last copy and the cover sheets for the last copy have been printed.

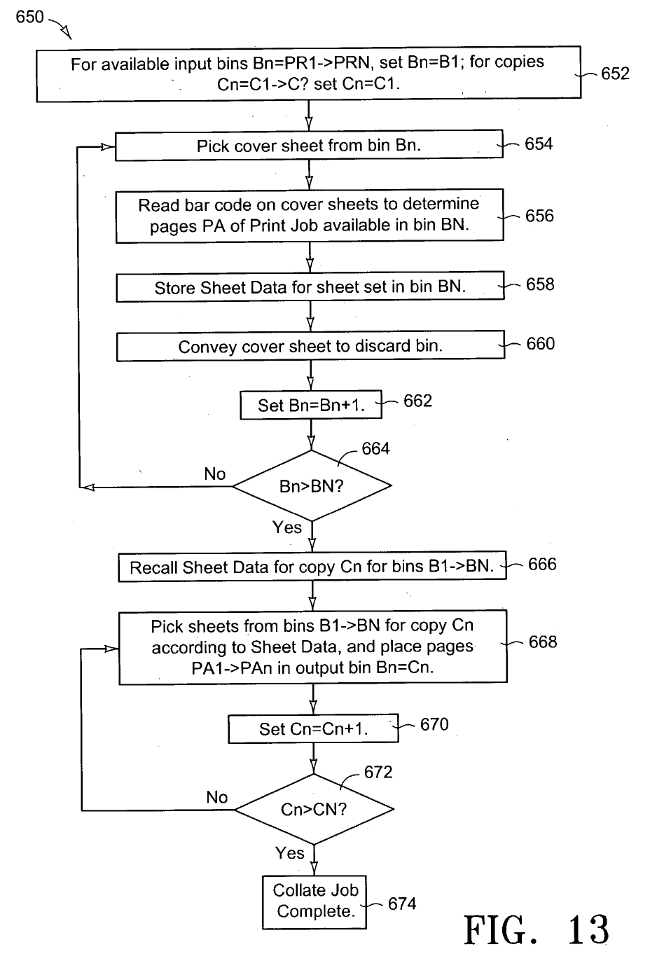

Turning now to FIG. 13, a flowchart 650 depicts a method of collating pages of a multi-page print document that can be printed using the just-described process depicted in the flowchart 600 of FIG. 12. The collating apparatus 300 depicted in FIG. 8 can be used to implement the process depicted in the flowchart 650 of FIG. 13. Accordingly, the following description of the flowchart 650 will make reference to the collating apparatus 300 of FIG. 8 in order to facilitate understanding the flowchart 650, but it is understood that collating apparatus other than apparatus 300 of FIG. 8 can be used to implement the flowchart 650. The process of the flowchart 650 of FIG. 13 is initiated by a user placing the various sets produced by each of the print engines (e.g., print engines 110 of FIG. 3) into the input trays 325 (FIG. 8) of the collator 300, such that one set is placed in each input tray. The user can then use the user interface (361, FIG. 8) to instruct the collating apparatus 300 to perform the collating process. The flowchart 650 (FIG. 13) assumes that the cover sheet for each set placed in an input tray 325 (FIG. 8) includes a bar code identifying the pages of each copy of the print job within that set, and that the bar code can thus be read by the bar-code readers 380 (FIG. 8). At step 652 (FIG. 13), the controller (330, FIG. 8) of the collator 300 sets a bin counter (which can be stored in RAM memory 334) for available bins “B1” through “BN” (corresponding to input trays 321, 322, 323 and 324 of FIG. 8, and generally identified as “Bn”) to the value “B1”. The controller (330, FIG. 8) also sets a copy counter (which can also be stored in RAM memory 334) to copy “C1”, for copies “C1” through as-yet unknown final copy “C?”. Then, at step 654 of the flowchart 650 (FIG. 13) the controller (330, FIG. 8) causes the first cover sheet to be picked from the first bin “B1” (“Bn” in FIG. 13, input tray 321, FIG. 8), and at step 656 the bar-code reader (380, FIG. 8) associated with the then-current bin “Bn” reads the print job log (136, FIG. 3, for example) from the-cover sheet. The data from the cover sheet identifies the pages “PA” of the print job that are in the bin “Bn”, and specifically the cover pages associated with each copy of the print job that are in the bin “Bn”. At step 658 (FIG. 13) the information read from the cover sheet in the bin “Bn” is stored in a “Sheet Data File” (such as sheet data log 336, FIG. 8), and then at step 660 the cover sheet is conveyed to a discard bin (such as discard output tray 358, FIG. 8). At step 662 (FIG. 13) the bin counter is incremented by a value of one, and at step 664 the controller (330, FIG. 8) checks to see whether the then-current value in the bin counter exceeds the number of available bins (input trays 325, FIG. 8). If the then-current value in the bin counter does not exceed the number of available input bins, then the cover sheet in the then-current bin is picked and read at steps 654 and 656, and the data stored in the sheet data log (336, FIG. 8). The process described in steps 654 through 664 continues until all of the cover sheets in the input bins (325, FIG. 8) have been read and the information recorded in the sheet data log (336, FIG. 8).

Once all of the cover sheets have been read, at step 666 of the flowchart 650 (FIG. 13), the controller (330, FIG. 8) recalls the sheet data log (336, FIG. 8) and reads the information to determine which pages of the first copy “C1” are in which bins “Bn”. At this time, the controller (330, FIG. 8) will also be able to determine from the sheet data log (336, FIG. 8) the total number of copies “CN” in the print job. The controller 330 (FIG. 8) then causes the sheet-handling components 385 (FIG. 8) to pick the sheets from the input trays 325 corresponding to the first copy of the print job, and to place them in the first output bin (351, FIG. 8) in the correct order to assemble the first copy of the print job, as per step 668 of the flowchart 650 (FIG. 13). At step 670 the copy counter is incremented by the value of 1, and a check is made at step 672 to determine whether the copy counter exceeds the total number of copies “CN” in the print job. If not, the controller returns to step 668 to pick the pages for the copy currently identified in the copy counter, and place them in the next-available output tray 359 (FIG. 8). Once all of the copies have been collated, the process is terminated at step 674.

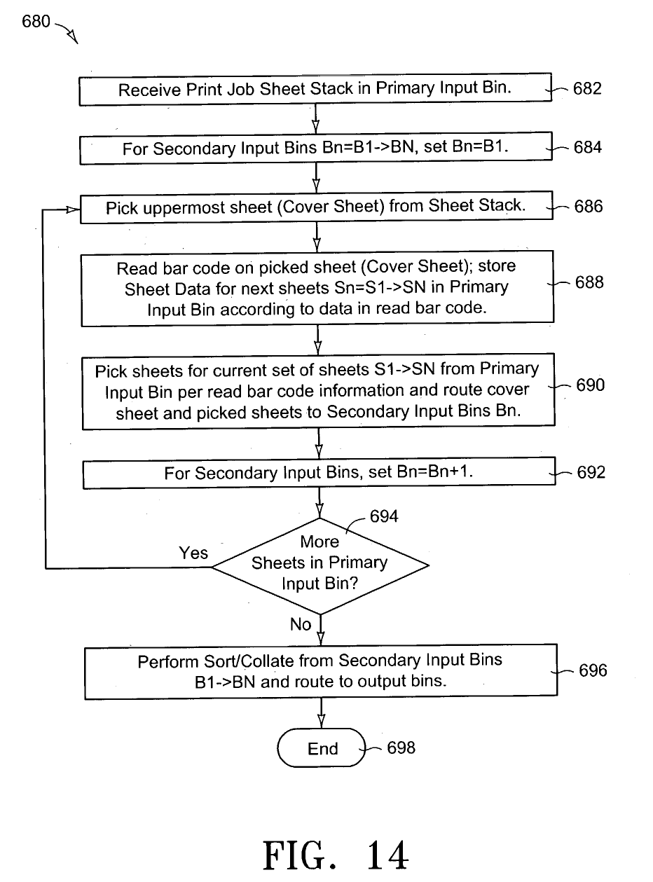

Turning now to FIG. 14, a flowchart 680 depicts a method of collating pages of a multi-page print document that can be printed using the above-described process depicted in the flowchart 600 of FIG. 12. The collating apparatus 400 depicted in FIG. 9 can be used to implement the process depicted in the flowchart 680 of FIG. 14. Accordingly, the following description of the flowchart 680 will make reference to the collating apparatus 400 of FIG. 9 in order to facilitate understanding the flowchart 680, but it is understood that collating apparatus other than apparatus 400 of FIG. 9 can be used to implement the flowchart 680. The process of the flowchart 680 (FIG. 14) is initiated by a user placing all of the various sets produced by each of the print engines (e.g., print engines 110 of FIG. 3) into the primary input tray 401 (FIG. 9) of the collator 400. That is, the various sets are provided to the input tray 401 in the form of a single sheet stack. The user can then use the user interface (461, FIG. 9) to instruct the collating apparatus 400 to perform the collating process. The flowchart 680 (FIG. 14) assumes that the cover sheet for each set placed in an input tray 401 (FIG. 9) includes a bar code identifying the pages of each copy of the print job within that set, and the bar code can thus be read by the bar-code reader 481 (FIG. 9). The flowchart 680 (FIG. 14) further assumes that each set in the sheet stack placed in the primary input tray 401 is separated by a cover sheet. At step 682 of the flowchart 680 (FIG. 14), the controller (430, FIG. 9) of the collator 400 detects the sheet stack (e.g., using the sheet stack detector 427, FIG. 9), and at step 684 (FIG. 14) sets a secondary bin counter for secondary bins “Bn” of “B1 through “BN” (corresponding to secondary input trays 421, 422, 423 and 424, FIG. 9) to “B1” (corresponding to tray 421). Then at step 686 (FIG. 14) the controller (430, FIG. 9) causes the uppermost sheet (which will be a cover sheet) to be picked from the sheet stack in the primary input tray 401 (FIG. 9). (It will be noted that the “uppermost sheet” in the primary input tray 401 of FIG. 9 is the sheet presented to the pick roller 462.) At step 688 (FIG. 14) the bar code on the just-picked sheet is read, and the controller (430, FIG. 9) will thus be able to determine the number of following sheets in the sheet stack which belong to a set “Sn” associated with the just-picked cover sheet. The controller will record this information in a primary sheet data log (435, FIG. 9). The information included in the cover sheet can also include the number of sets which will constitute the final print job, and so the controller (430, FIG. 9) will be able at this point to determine the number of sets present in the primary input tray 401, and allocate secondary input trays 425 accordingly. At step 690 (FIG. 14) the just-picked cover sheet, and the following sheets in the set identified by the cover sheet, are routed to the first secondary input tray 421, and at step 692 the secondary bin counter is incremented by the value of one. The controller (430, FIG. 9) then polls the sheet detector 427 to determine if more sheets are present in the primary input tray 401, as indicated at step 694 (FIG. 14). If more sheets are in the primary input tray 401 (FIG. 9), then the process returns to step 686 (FIG. 14), and the next cover sheet is picked. The process continues until no more sheets are in the primary input tray 401, at which point control moves to step 696 (FIG. 14) where the sort process on the sheets in the secondary input trays (425, FIG. 14) is then performed. An example of how the collating process step 696 can be performed was given above with respect to FIG. 13, except that the sets will have been automatically placed in the secondary input trays 425 (FIG. 14) by the sheet handling components 490 (FIG. 9), rather than being placed manually in the secondary input trays 425 (as was the case in the example described in flowchart 650 of FIG. 14).

It will be appreciated that the flowcharts depicted in FIGS. 10 through 14 are exemplary only, and that additional, fewer and/or alternate steps can be used, all in accordance with embodiments of the present invention. For example, in the printing processes described in flowcharts 500 (FIG. 10), 550 (FIG. 11), and 600 (FIG. 12), and as indicated earlier with respect to the description of operation of the printing system 100 of FIG. 3, a page of the print job does not have to fully printed and placed in an output tray before printing of the next page of the print job can begin. In this case, the flowcharts can include an additional step wherein the controller (e.g., 104, FIG. 3) polls the print engines (e.g., 110, FIG. 3) for an error signal to determine is a previously transmitted page has been printed. In one example, if page PAn is transmitted for printing, and then page PAn+1 is transmitted, then before transmitting page PAn+2 the controller can poll the print engine that is supposed to be printing page PAn before transmitting page PAn+2. If an error signal is detected at the polled print engine, then the controller can resend page PAn to a different print engine. A further embodiment of the present invention provides for a method of printing a multi-page print job. The method includes providing a plurality of print engines (e.g., print engines 110 of FIG. 3), identifying a first available print engine from among the plurality of print engines, and printing a first page of the multi-page print job from the first available print engine. The method further includes identifying a next available print engine from the plurality of print engines, and printing a next page of the multi-page print job from the next available print engine. The method can further include repeating the acts of identifying a next available print engine from the plurality of print engines and printing a next page of the multi-page print job from the next available print engine, until all pages of the multi-page print job have been printed. As described above, the method can also include generating a log (such as print job log 134 of FIG. 3, an example of which is given in FIG. 4B) which identifies each page of the multi-page print job that was printed by each of the plurality of print engines. Further examples of this method of printing a multi-page document are provided in the flowcharts depicted in FIGS. 10,11 and 12, described above.

In another embodiment, the just-described method can further include reading the log (e.g., the print job log 134 of FIG. 3) to acquire information identifying which pages of the multi-page print job have been printed by each of the print engines, and then assembling the pages printed by the plurality of print engines into the print job using the acquired information. In one example, the log can be read by a controller (such as controllers 230, 330 or 430 or respective FIGS. 7, 8 and 9), and the pages can be assembled by a collating/sorting apparatus (such as apparatus 220, 300 or 400, described above with respect to respective FIGS. 7, 8 and 9, and further described with respect to the flowcharts depicted in FIGS. 10, 11, 13 and 14, described above). As further described above, the act of assembling the pages of the multi-page print job (to thereby produce the final print job) can include either collating the pages (e.g., as depicted by print job “PJ1” of FIG. 1), or sorting the pages (e.g., as depicted by print job. “PJ2” of FIG. 2).

While the pages of a print job printed according to the above-describe method can be collated or sorted manually, embodiments of the present invention also provide for automatically assembling the pages printed by the plurality of print engines into the print job. The collating/sorting apparatus 220, 300 and 400, described above with respect to respective FIGS. 7, 8 and 9, provide specific examples of how the pages of the multi-page print job (printed in accordance with the above-describe method) can be automatically assembled into the final print job.

In one variation on the above-described method of printing a multi-page print job, the method can further include printing information on a cover sheet (e.g., cover sheet 10 of FIG. 5) which identifies each page of the multi-page print job that was printed by a print engine used to print the print job. As described above, each print engine can print a cover page identifying those pages of the multi-page print job printed by that particular print engine. When such information is printed on cover sheets by the print engines used to print the multi-page print job, then the method can further include reading the information on each cover sheet to determine which pages of the multi-page print job have been printed by each of the print engines. Once the information has been read from the cover sheets, the pages printed by the plurality of print engines can be assembled into the final print job according to the information read from the cover sheets. The information on the cover sheet can be in human-readable form, in which case the pages for the plurality of print engines can be assembled manually into the final print job according to this information. However, when the information on the cover sheet is provided in machine-readable form (such as a bar code or the like), then the pages can be assembled automatically (such as by collating/sorting apparatus 300 or 400 of respective FIGS. 8 and 9). An example of a machine-readable form on a cover sheet is bar code 14 on cover sheet 10 of FIG. 5. The bar code 14 of FIG. 5 can be read by the bar-code readers 380 and 481 of FIGS. 8 and 9, to thereby allow pages printed by the above-described method to be placed into a plurality of input trays (325, FIG. 8, for example), or a single input tray (401, FIG. 9, for example). From there the pages can be automatically sorted or collated into output trays (359, FIG. 8, or 459, FIG. 9, for example) to produce the final print job.

In the above-described method of printing a multi-page print job, the acts of identifying the first available print engine to print the first page of the multi-page print job, and identifying the next available print engine to print the next available page of the multi-page print job, can be based on identifying print engines from the plurality of print engines that can immediately print the respective first page and second page of the multi-page print job. For example, if one of the print engines is currently printing a page of the print job (or is otherwise occupied in printing a different print job), then that printer will not be considered as being “next available” if another one of the print engines can immediately print the current page of the print job. Further, the acts of identifying the first available print engine to print the first page of the multi-page print job, and identifying the next available print engine to print the next available page of the multi-page print job, can also, or alternately, be based on identifying one or more print engines, from among the plurality of print engines, that are capable of printing the first page and the second page of the multi-page print job. The “capability” of a print engine to print a given page of the multi-page print job can be based on a type of imaging media on which the first and the second pages are to be printed, and availability of the imaging media to each of the plurality of print engines. For example, if a page of the print job is to be printed on letterhead paper, then only print engines having access to letterhead paper will be considered for availability to print the page. Other imaging media type considerations can include the size of the imaging media (e.g., letter size or legal size) and the kind of imaging media (e.g., plain paper, transparencies, photographic grade paper, envelopes, 20 weight paper versus 24 weight paper, etc.). The “capability” of a print engine to print a given page of the multi-page print job can be based on availability of an imaging substance to the each of the plurality of print engines. (“Imaging substance” is the substance used to form the image on a page, and can include, by way of example only, dry toner and liquid ink.) Thus, if a particular print engine does not have access to imaging substance (for example, a toner cartridge for the print engine is out of toner), then that print engine will not be “available” to print a page of the print job. In yet another example, the “capability” of a print engine to print a given page of the multi-page print job can be based on the capability of any of the print engines to generate an image in color. For example, if a print job calls for certain pages of the print job to be printed in color (versus black-and-white or grayscale), then print engines which cannot print in color will not be available to print those pages of the print job.

Yet a further embodiment of the present invention provides for a method of assembling pages of a multi-page print job into the print job. The method includes providing the pages of the multi-page print job as a plurality of sets of pages and determining, for each set, the pages of the multi-page print job in the set. The pages from the sets are then assembled into the print job according to the pages determined to be in each set. Examples of this method are provided in the flowcharts depicted in FIGS. 10, 11, 13 and 14, described above. The method can further include printing, for each set, a cover sheet identifying the pages of the multi-page print job contained within the set. The cover sheet can be printed manually or automatically. An example of a cover sheet which can be printed for each set is provided in FIG. 5, described above. An example of automatically printing the cover sheet was described above with respect to the flowcharts of FIGS. 10, 11 and 12. As also described above, the act of determining, for each set, the pages of the multi-page print job in the set further can include reading, either manually or automatically, each cover sheet for each set. Examples of automatically reading the cover sheet were described above. For example, the cover sheet can be the cover sheet 10 of FIG. 5, and can include the machine-readable bar code 14, in which case the bar-code reader 380 of FIG. 8, or the bar-code reader 481 of FIG. 9, can automatically read the cover sheet. The method of assembling the pages of the multi-page print job into the print job can further include generating a log identifying, for each set, the pages of the multi-page print job contained within the set. An example of such a log is depicted in FIG. 4B, which was described above. The log can be generated automatically, as described with respect to the flowcharts 500, 550 and 600 of respective FIGS. 10, 11 and 12. The log can then be read to determine, for each set, the pages of the multi-page print job in the set. As described above, the log can be stored in a computer readable memory device (such as RAM memory devices 236, 336 and 436 of respective FIGS. 7, 8 and 9), and can be read by respective processors 232, 332 or 432 in order that the log-reading process can be performed automatically.

We claim:

1. A printing system, comprising:
a computer configured to present a document file for printing as a multi-page print job;
a plurality of print engines accessible by the computer; and
a controller configured to identify, for each page to be printed of the multi-page print job, a next-available print engine from the plurality of print engines for printing the page, and to cause the next available print engine to print the page.

2. The printing system of claim 1, and wherein the controller comprises a network controller, and wherein the computer is configured to access the plurality of print engines via the network controller.

3. The printing system of claim 2, and wherein the plurality of print engines are resident within a plurality of stand-alone printers in signal communication with the network controller.

4. The printing system of claim 1, and wherein:
each of the plurality of print engines comprises an associated output tray;
each print engine which prints at least one page of the print job produces the at least one page in the associated output tray; and
the controller is further configured to record in a print log the pages of the print job output by each print engine to its associated output tray.

5. The printing system of claim 4, and wherein the controller is further configured to read the print log and cause each print engine which prints at least one page of the print job to print a cover sheet identifying the pages of the print job printed by the respective, print engine, and to produce each cover sheet to the associated output tray.

6. The printing system of claim 5, and wherein the pages of the print job printed on each cover sheet are identified in machine-readable form.

7. The printing system of claim 5, and wherein the pages of the print job printed on the cover sheet are identified in human-readable form.

8. The printing system of claim 4, and further comprising a collating apparatus configured to receive the pages of the print job from the output trays of the plurality of print engines, and wherein the controller is further configured to read the print log and to use the print log to direct the collating apparatus to perform one of a sorting process or a collating process on the pages to thereby place the pages into the final form of the print job.

9. The printing system of claim 8, and wherein the output trays of the plurality of print engines act as a plurality of input trays for the collating apparatus.

10. The printing system of claim 9, and further comprising a printing apparatus enclosure, and wherein the plurality of print engines and the collating apparatus are resident within the printing apparatus enclosure.

11. The printing system of claim 6, and wherein the controller is a print engine controller, the system further comprising a collating apparatus configured to receive the pages of the print job from the output trays of the plurality of print engines, the collating apparatus comprising:
a code-reading apparatus configured to read the machine-readable form of the pages of the print job printed on each cover sheet and to generate sheet data in response thereto; and
a collate/sort controller configured to use the sheet data to direct the collating apparatus to perform one of a sorting process or a collating process on the pages to thereby place the pages into the final form of the print job.

12. A printing apparatus for printing a document file as a multi-page print job, comprising:
a plurality of print engines, each print engine comprising an associated print engine output tray;
a controller configured to identify, for each page to be printed of the multi-page print job, a next-available print engine from the plurality of print engines for printing the page, and to cause the next available print engine to print the page and to discharge the page to the associated print engine output tray;
a collator configured to receive the pages of the multi-page print job from the output trays, the collator comprising at least one collator output tray; and
wherein the controller is further configured cause the collator to draw the pages from the print engine output trays, to perform one of a sort process or a collate process on the pages, and to place the pages in the at least one collator output tray.

13. The printing apparatus of claim 12, and wherein:
the collator comprises a plurality of collator output trays; and
the controller is further configured cause the collator to draw the pages from the print engine output trays, to perform one of a sort process or a collate process on the pages, and to place the pages in the plurality of collator output trays.

14. The printing apparatus of claim 13, and wherein the controller is further configured to record in a print log the pages of the print job output by each print engine to its associated print engine output tray.

15. The printing apparatus of claim 14, and wherein the controller is further configured to read the print log and to use the print log to direct the collating apparatus to perform one of a sorting process or a collating process on the pages in the plurality of print engine output trays to thereby place the pages into the final form of the print job in the plurality of collator output trays.

16. The printing apparatus of claim 15, and further comprising a printing apparatus enclosure, and wherein the plurality of print engines, the collator, and the controller are all resident within the printing apparatus enclosure.

17. The printing apparatus of claim 15, and further comprising a printing apparatus enclosure, and wherein the plurality of print engines and the collator are resident within the printing apparatus enclosure, and the controller is resident outside of the printing apparatus enclosure.

18. A collating apparatus, comprising:
a plurality of input trays configured to receive pages of a multi-page print job;
a plurality of output trays configured to receive the multi-page print job; and
a controller configured to cause the collating apparatus to draw the pages from the plurality of input trays, to perform one of a sort process or a collate process on the pages, and to place the pages in the plurality of output trays in the form of the print job.

19. The collating apparatus of claim 18, and wherein pages of the multi-page print job to be received within each of the plurality of input trays is to be provided with a cover sheet specifying in machine-readable form the specific pages of the print job placed within each of the plurality of input trays, the collating apparatus further comprising:
a code-reading apparatus configured to read the machine-readable form of the pages of the print job printed on each cover sheet, and to generate sheet data in response thereto; and
wherein the controller is further configured to use the sheet data to direct the collating apparatus to perform one of the sorting process or the collating process on the pages.

20. The collating apparatus of claim 19, and wherein the machine readable form printed on the cover sheets is in the form of a bar code, and wherein the code reading apparatus comprises a plurality of bar-code readers, each bar-code reader being associated with a respective input tray.

21. The collating apparatus of claim 18, and further comprising:
a plurality of input guides, each input guide being associated with a respective input tray and configured to receive pages of the print job from the respective input tray;
a central sheet guide configured to receive pages of the print job from the plurality of input guides;
a plurality of output guides, each output guide being associated with a respective output tray and configured to receive pages of the print job from the central sheet guide.

22. The collating apparatus of claim 21, and further comprising:
a plurality of selectively reversible sheet drives placed along the central sheet guide and configured to selectively drive pages of the print job in the central sheet guide in opposing first and second directions; and
a plurality of diverter gates, each diverter gate being positioned relative to the central sheet guide and an associated output guide, each diverter gate being selectively actuatable to cause pages in the central sheet guide to be diverted from the central sheet guide to an output tray associated with the diverter gate.

23. The collating apparatus of claim 18, and wherein:
the plurality of input trays are secondary input trays, the collating apparatus further comprising a primary input tray configured to receive all of the pages of the multi-page print job; and
the controller is further configured to cause the collating apparatus to draw the pages from the primary input tray, to perform a sort process on the pages, and to place the pages in the plurality of secondary input trays.

24. The collating apparatus of claim 23, and wherein the pages of the multi-page print job are provided to the primary input tray as a plurality of sets, each set being provided with a respective cover sheet, each cover sheet comprising a machine-readable code identifying the pages of the print job in the associated set, the collating apparatus further comprising:
a code-reading device configured to read the machine-readable code on each cover sheet, and to generate sheet data in response thereto; and
a controller configured to use the sheet data to direct the collating apparatus to place each set in an associated secondary input tray.

25. The collating apparatus of claim 24, and further comprising:
an input guide configured to receive the pages of the print job from the primary input tray;
a central sheet guide configured to receive pages of the print job from the input guide; and
a plurality of output guides, each output guide being associated with a respective secondary input tray and configured to receive pages of the print job from the central sheet guide.

26. A method of printing a multi-page print job, comprising:
providing a plurality of print engines;
identifying a first available print engine from the plurality of print engines;
printing a first page of the multi-page print job from the first available print engine;
identifying a next available print engine from the plurality of print engines;
printing a next page of the multi-page print job from the next available print engine.

27. The method of claim 26, and further comprising repeating identifying a next available print engine from the plurality of print engines, and printing a next page of the multi-page print job from the next available print engine, until all pages of the multi-page print job have been printed.

28. The method of claim 27, and further comprising generating a log identifying each page of the multi-page print job that was printed by each of the plurality of print engines.

29. The method of claim 28, and further comprising:
reading the log to acquire information identifying which pages of the multi-page print job have been printed by each of the print engines; and
assembling the pages printed by the plurality of print engines into the multi-page print job using the acquired information.

30. The method of claim 29, and wherein assembling the pages printed by the plurality of print engines into the print job comprises collating the pages.

31. The method of claim 29, and wherein assembling the pages printed by the plurality of print engines into the print job comprises sorting the pages.

32. The method of claim 29, and wherein assembling the pages printed by the plurality of print engines into the print job is performed automatically.

33. The method of claim 27, and further comprising, for each print engine, printing information on a cover sheet identifying each page of the multi-page print job that was printed by the respective print engine.

34. The method of claim 33, and further comprising:
reading the information on each cover sheet to determine which pages of the multi-page print job have been printed by each of the print engines; and
assembling the pages printed by the plurality of print engines into the print job according to the information read from the cover sheets.

35. The method of claim 34, and wherein assembling the pages printed by the plurality of print engines into the print job comprises collating the pages.

36. The method of claim 34, and wherein assembling the pages printed by the plurality of print engines into the print job comprises sorting the pages.

37. The method of claim 34, and wherein assembling the pages printed by the plurality of print engines into the print job is performed automatically.

38. The method of claim 26, and wherein identifying the first available print engine to print the first page of the multi-page print job, and identifying the next available print engine to print the next available page of the multi-page print job, is based on identifying print engines from the plurality of print engines that can immediately print the respective first page and second page of the multi-page print job.

39. The method of claim 26, and wherein identifying the first available print engine to print the first page of the multi-page print job, and identifying the next available print engine to print the next available page of the multi-page print job, is based on identifying one or more print engines, from among the plurality of print engines, that are capable of printing the first page and the second page of the multi-page print job.

40. The method of claim 39, and wherein identifying one or more print engines, from among the plurality of print engines, that are capable of printing the first page and the second page of the multi-page print job is based on at least one of:
a type of imaging media on which the first and the second pages are to be printed, and availability of the imaging media to each of the plurality of print engines;
availability of an imaging substance to the each of the plurality of print engines; and
capability of any of the print engines to generate an image in color.

41. A method of assembling pages of a multi-page print job into the print job, comprising:
providing the pages of the multi-page print job as a plurality of sets of pages;
determining, for each set, the pages of the multi-page print job in the set; and
assembling the pages from the sets into the print job according to the pages determined to be in each set.

42. The method of claim 41, and further comprising printing, for each set, a cover sheet identifying the pages of the multi-page print job contained within the set.

43. The method of claim 42, and wherein determining, for each set, the pages of the multi-page print job in the set further comprises reading each cover sheet for each set.

44. The method of claim 43, and wherein printing the cover sheets and reading the cover sheets are performed automatically.

45. The method of claim 41, and further comprising generating a log identifying, for each set, the pages of the multi-page print job contained within the set.

46. The method of claim 45, and wherein determining, for each set, the pages of the multi-page print job in the set further comprises reading the log.

47. The method of claim 46, and wherein generating the log and reading the log are performed automatically.
